(19) United States
(12) Patent Application Publication
(10) Pub. No.: US 2025/0064260 A1
(43) Pub. Date: Feb. 27, 2025

(54) Portable Automated Wok Agitation System

(71) Applicant: RANGE ROBOTICS INC, Philadelphia, PA (US)

(72) Inventor: Kyle Naddeo, Clementon, NJ (US)

(21) Appl. No.: 18/815,784

(22) Filed: Aug. 26, 2024

Related U.S. Application Data
(60) Provisional application No. 63/578,884, filed on Aug. 25, 2023.

(51) Int. Cl. A47J 37/10; A47J 44/00

(52) U.S. Cl. CPC A47J 37/108; A47J 44/00

(57) ABSTRACT

A portable automated wok agitation system is a system that facilitates an automated wok pan agitation process, effectively replicating the dexterity and precision exhibited by a professional human wok chef. The system includes a mounting plate, a motorized arm assembly, a motorized wrist assembly, a controller, and a portable power source. The mounting plate supports the moving components of the system and facilitates the mounting of the system to the desired wok range. The motorized arm assembly generates the “arm” movements required to agitate the wok during the cooking process. The motorized wrist assembly generates the “wrist” movements required to flip and move the food products in the wok during the cooking process. The motorized wrist assembly supports the desired wok in the proper orientation above the wok range. The controller and the portable power source facilitate the automated operation of the motorized arm assembly and the motorized wrist assembly.

### FIELD OF THE INVENTION

The present invention relates generally to portable kitchen appliances and automatic cooking systems. More specifically, the present invention discloses a portable cooking system that facilitates the automated agitation process of a cooking pan, such as a wok or other cooking pans with elongated handle.

### BACKGROUND OF THE INVENTION

A wok is a versatile and traditional cooking utensil originating from Asia. In general, a wok is a round-bottomed pan with high-sloping sides and is typically made from materials like carbon steel, cast iron, or stainless steel. The unique design of the wok allows for even heat distribution of the food products being cooked and facilitates the efficient use of different cooking methods including stir-frying, searing, sauteing, etc. In addition, the concave shape of the wok's bottom allows ingredients to be pushed to the sides, while the center retains the intense heat necessary for rapid cooking. Traditional woks often have an elongated handle from which the chef manipulates the wok during the cooking process. The proper manipulation of the wok requires controlled coordination of arm and wrist motions to stir the different ingredients in the wok during the cooking process. The motions involved in the proper control of the wok can be complex, which requires vast training of a chef to properly use a wok. It would be beneficial for chefs to have a portable system that automatically operates a wok during the cooking process of the desired food products.

Therefore, an objective of the present invention is to provide a portable automated wok agitation system. The present invention discloses a portable and battery-powered system designed to automate the wok agitation process. The present invention can be securely attached to any wok range via a versatile mounting mechanism that enables the controlled positioning of the system along two degrees of freedom relative to the wok range. Another objective of the present invention is to provide a portable automated wok agitation system that can support different types of woks. The present invention utilizes a mechanism that securely holds the wok during the agitation process adjacent to the flame from the wok range. Further, the present invention can accommodate other cooking pans with elongated handles and can be mounted onto different commercial and/or residential cooking ranges.

Another objective of the present invention is to provide a portable automated wok agitation system that utilizes machine learning to map the wok's trajectory using learned data from professional chefs' movements. The mapping process tracks not only the position of the wok but also the velocity and acceleration. The control algorithm influences the agitation process, while the design algorithm adjusts the system's geometry to meet the desired trajectory, positioning, and speed. Another objective of the present invention is to provide portable automated wok agitation system that can mimic the flipping motion of the ingredients being cooked on the wok. The present invention implements a system that can emulate the complex motion characteristics of a wok pan under human control. These movements are modeled after those observed in professional chefs, enabling the system to achieve a truly human-like cooking performance. Additional features and benefits of the present invention are further discussed in the sections below.

### SUMMARY OF THE INVENTION

The present invention discloses a portable automated wok agitation system designed to revolutionize the automation of the wok agitation process. The present invention mirrors the skill and precision of a professional human wok chef. Versatility is a key attribute, as the present invention is compatible with any wok range deck and wok type. To do so, the present invention includes a motorized arm assembly with an inverted slider crank mechanism that generates the desired “arm” movements to agitate the wok. In addition, the present invention includes a motorized wrist assembly with a four-bar linkage that generates the “wrist” movements to agitate the wok. These mechanisms of the present invention are operated simultaneously to generate human-like motion that agitates the wok during the cooking process. In addition, the present invention can accommodate other cooking pans with an elongated handle, and the present invention may be accommodated to be mounted onto different commercial and/or residential cooking ranges.

Further, the system of the present invention utilizes two distinct machine learning algorithms: a movement control algorithm and a geometric design algorithm. These algorithms learn from the movements of professional chefs that are manually labeled, and the collected data is used in a supervised manner to train the system to mimic specific wok motions effectively. The movement control algorithm manipulates the arm and wrist movements of the system, while the geometric design algorithm adjusts the geometry path of the movements. Further, the system of the present invention can modify the speed of the movements, while simultaneously setting the position, speed, and mechanical advantage of the geometry. Notably, the present invention can capture the elusive “Wok Hei”—the ‘breath of a wok’—a unique flavor found exclusively in traditional wok cooking. By ensuring meticulous mixing, thorough ingredient integration, and even heat distribution, the present invention significantly enhances the culinary experience in an automated manner.

### BRIEF DESCRIPTION OF THE DRAWINGS

FIG. 1 is a top-front-left perspective view of the present invention, wherein the system of the present invention is shown attached onto a wok range.

FIG. 2 is a left-side view of the present invention thereof.

FIG. 3 is a top-front-right perspective view of the present invention, wherein the preferred embodiment of the system is shown.

FIG. 4 is a bottom-front-right perspective of the present invention thereof.

FIG. 5 is a right-side view of the present invention thereof.

FIG. 6 is a right-side view of the present invention, wherein the front legs of the system are shown deployed, and wherein the dropdown locks of the system are shown retracted.

FIG. 7 is a bottom-front-right perspective of the present invention thereof.

FIG. 8 is a right-side view of the present invention, wherein the front legs and the dropdown locks of the system are shown retracted, and wherein the system is shown with a power source housing.

FIG. 9 is a bottom-front-right perspective of the present invention thereof.

FIG. 10 is a top-front-right perspective view of the present invention, wherein the mounting plate, the motorized arm assembly, and the motorized wrist assembly of the system are shown, and wherein a wok is shown attached to the adjustable jaw clamp of the motorized wrist assembly.

FIG. 11 is a right-side view of the present invention thereof.

FIG. 12 is a top-front-right perspective view of the present invention thereof, wherein the system is shown without a wok.

FIG. 13 is a top-front-left perspective view of the present invention thereof.

FIG. 14 is a right-side view of the present invention thereof.

FIG. 15 is a right-side view of the present invention thereof, wherein the arm motor is shown engaged to move the motorized arm assembly.

FIG. 16 is a right-side view of the present invention thereof wherein the arm motor is shown engaged to move the motorized arm assembly.

FIG. 17 is a right-side view of the present invention thereof, wherein the arm motor is shown engaged to move the motorized arm assembly.

FIG. 18 is a right-side view of the present invention thereof, wherein the at least one servomotor is shown engaged to move the motorized wrist assembly.

FIG. 19 is a top-rear-right perspective view of the mounting clamp assembly of the system of the present invention.

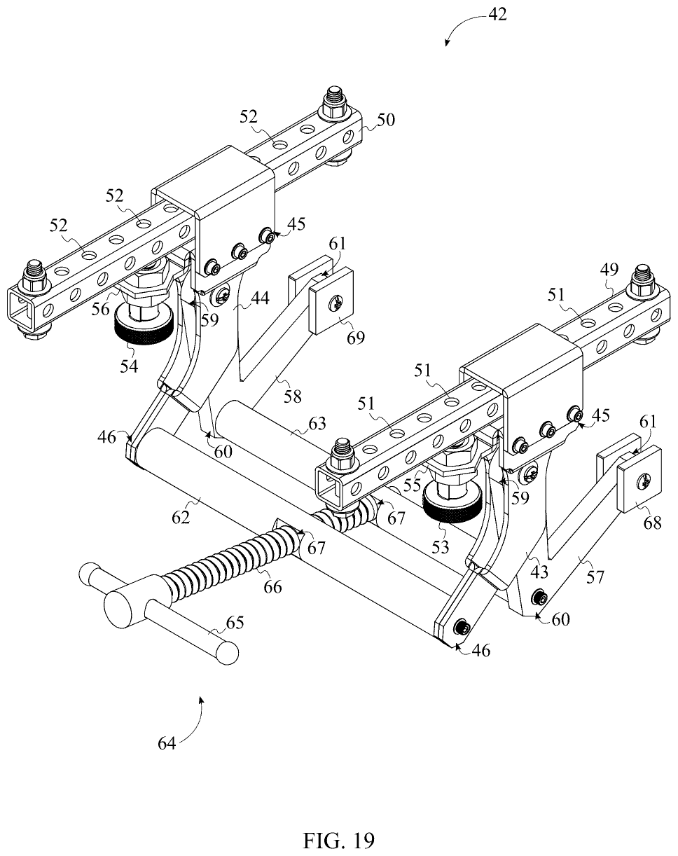

FIG. 20 is a bottom-rear-left perspective view of the mounting clamp assembly of the system of the present invention.

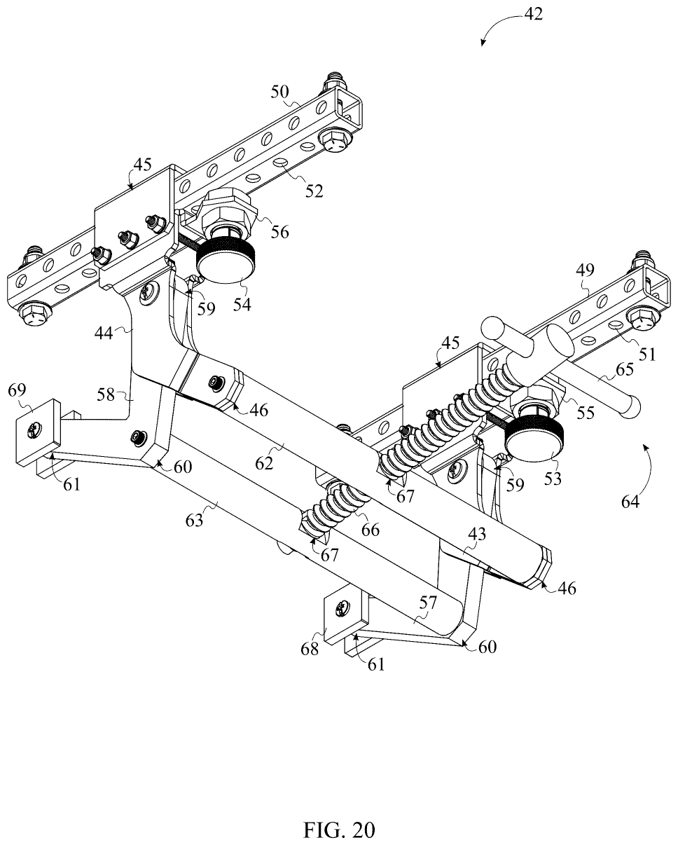

FIG. 21 is a bottom-rear-left perspective view of the second dropdown lock of the system of the present invention.

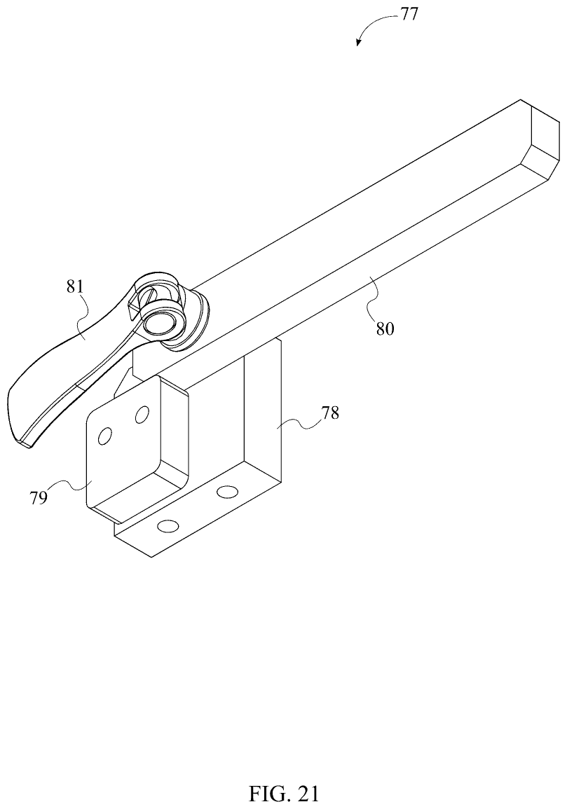

FIG. 22 is a bottom-front-right perspective view of the first dropdown lock of the system of the present invention.

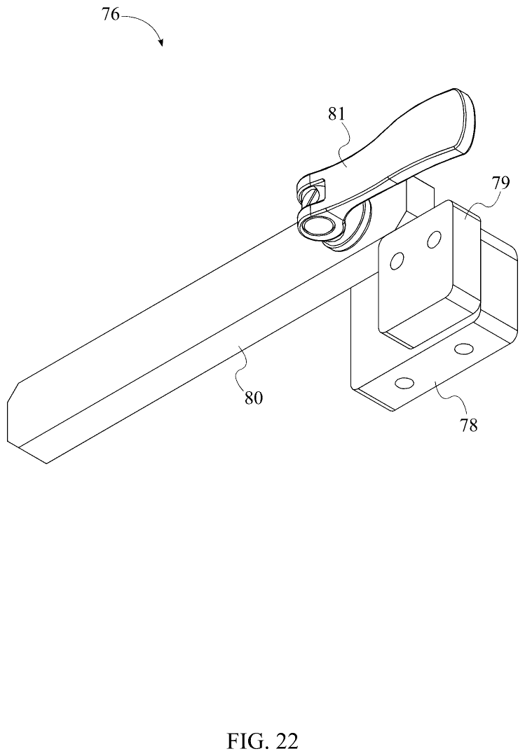

FIG. 23 is a top-front-right perspective view of the motorized arm assembly of the system of the present invention.

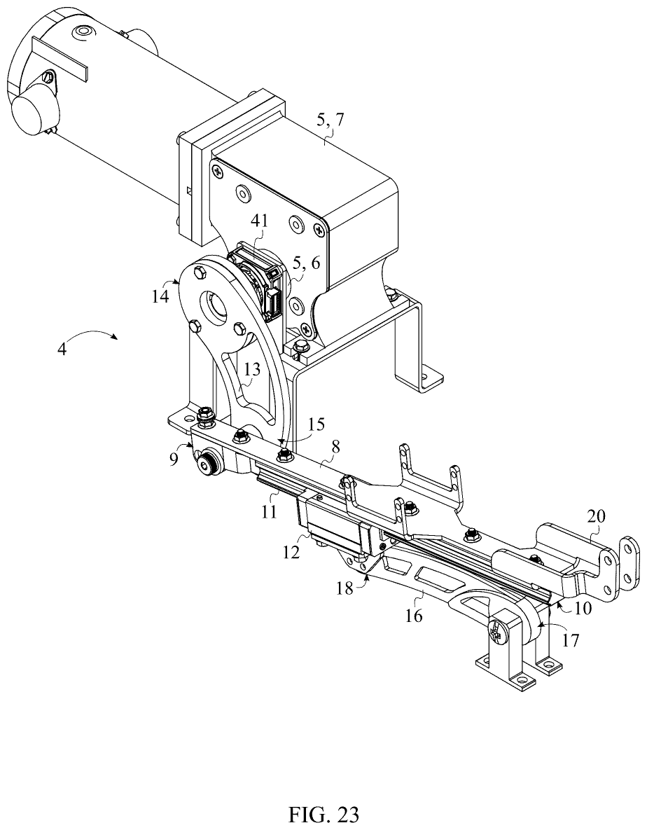

FIG. 24 is a right-side view of the motorized arm assembly of the system of the present invention.

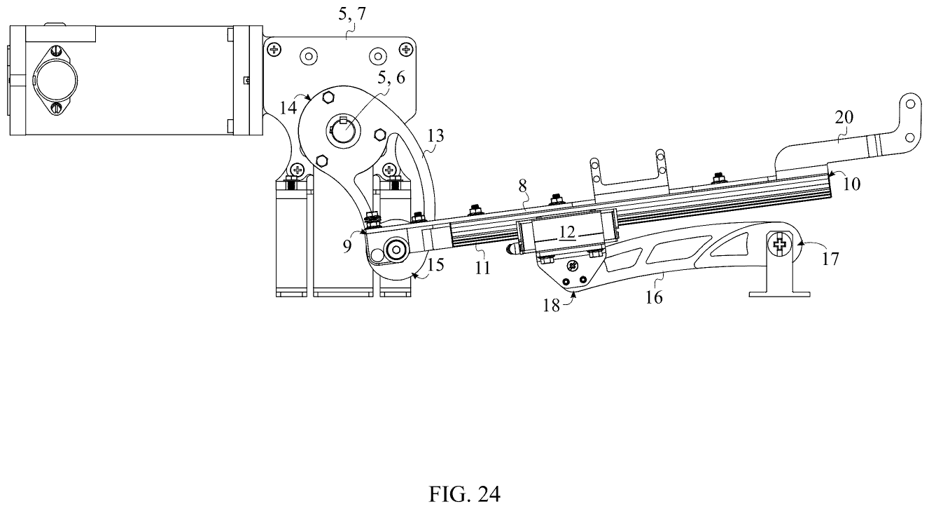

FIG. 25 is a top-front-right perspective view of the motorized wrist assembly of the system of the present invention.

FIG. 26 is a right-side view of the motorized wrist assembly of the system of the present invention.

FIG. 27 is a top-front-right perspective view of the adjustable jaw clamp of the motorized wrist assembly of the system of the present invention.

FIG. 28 is a top-rear-left perspective view of the adjustable jaw clamp of the motorized wrist assembly of the system of the present invention.

FIG. 29 is a left-side view of an alternate embodiment of the present invention, wherein the system is shown with a scissor lift mechanism.

FIG. 30 is a block diagram showing the electrical connections and the electronic connections of the system of the present invention, wherein the electrical connections are shown in solid lines, and wherein the electronic connections are shown in dashed lines.

### DETAIL DESCRIPTIONS OF THE INVENTION

All illustrations of the drawings are for the purpose of describing selected versions of the present invention and are not intended to limit the scope of the present invention.

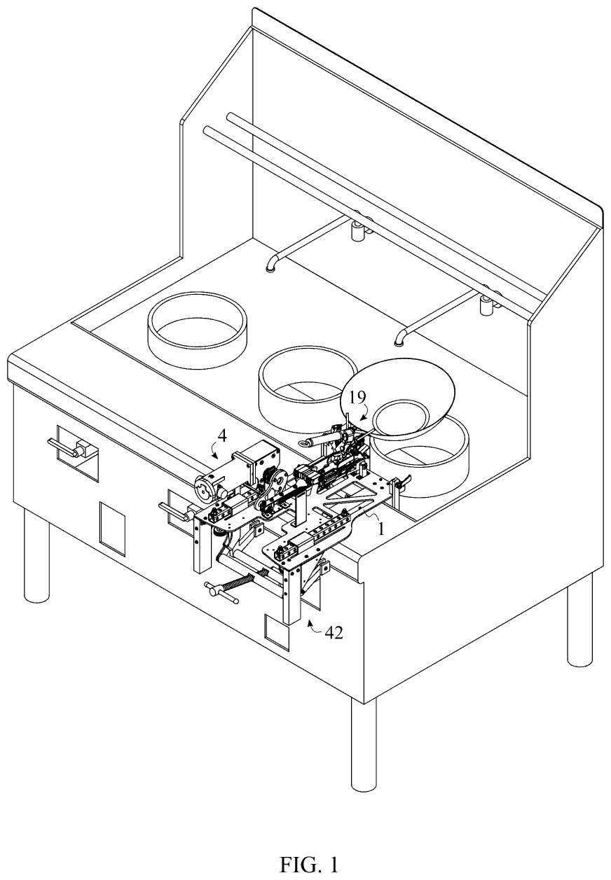

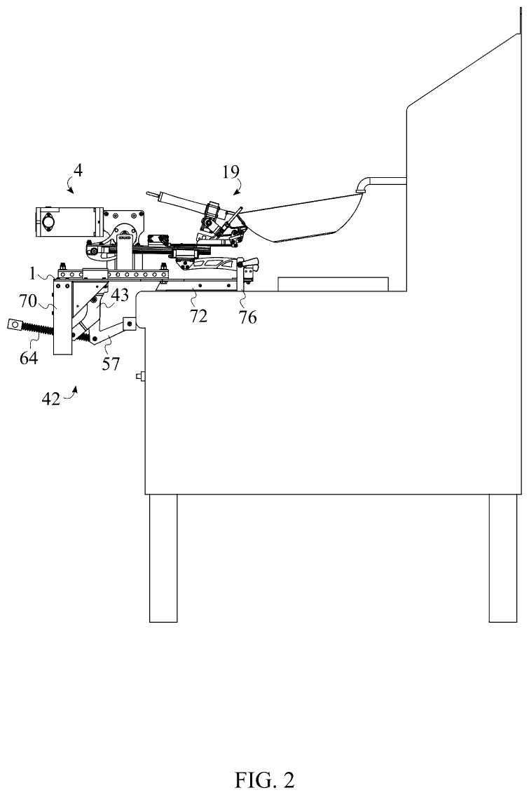

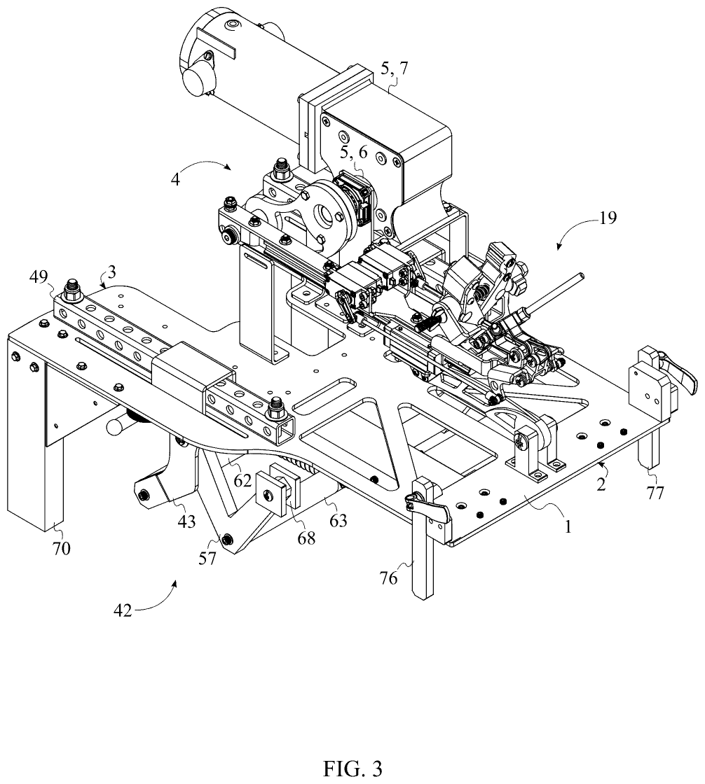

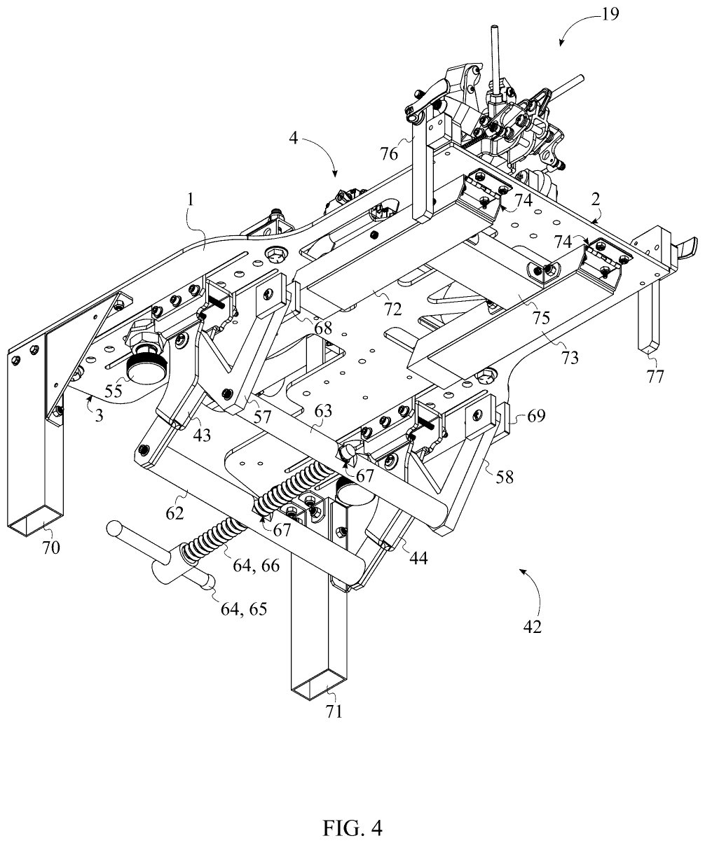

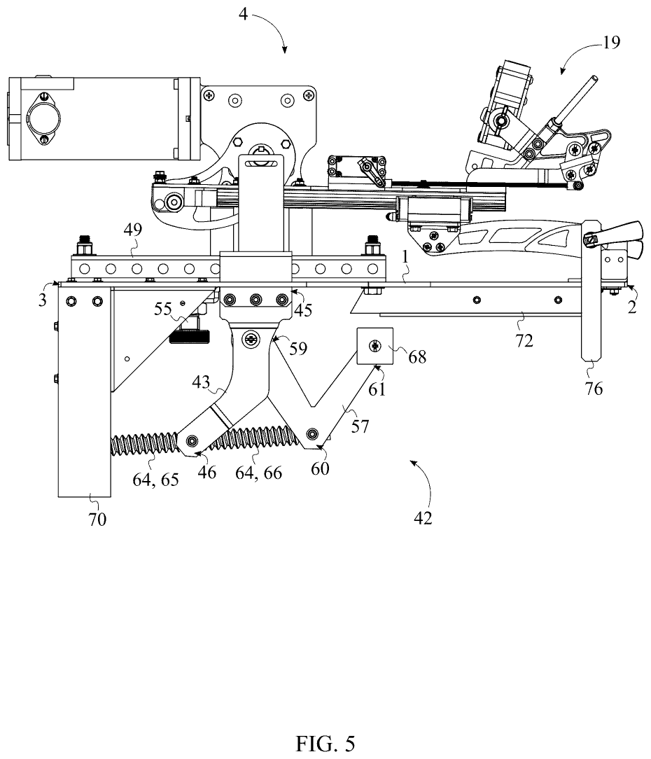

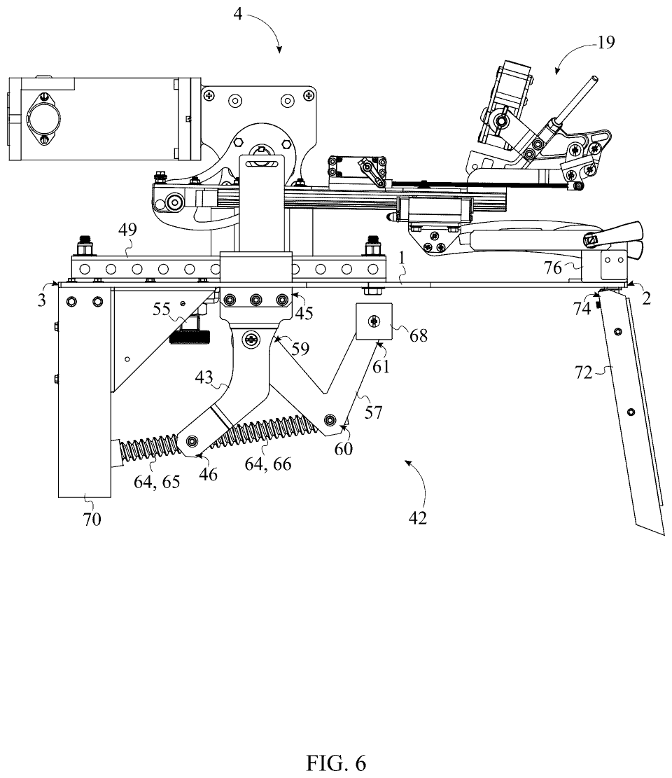

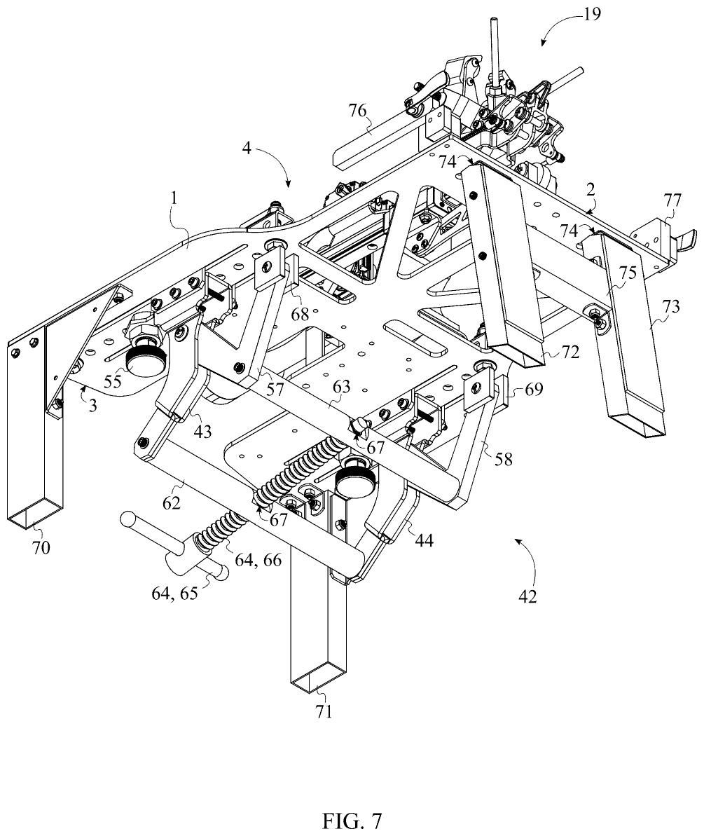

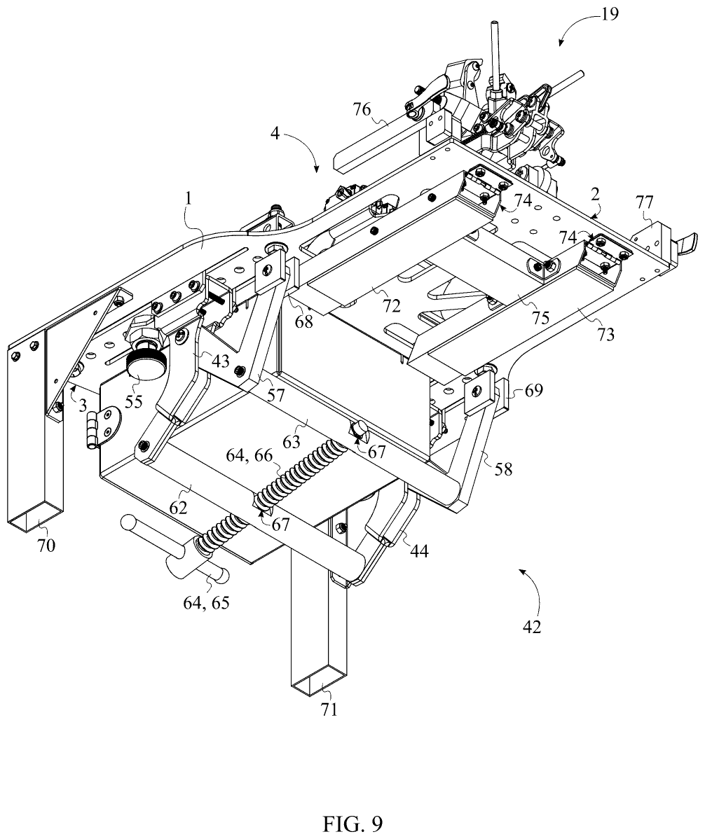

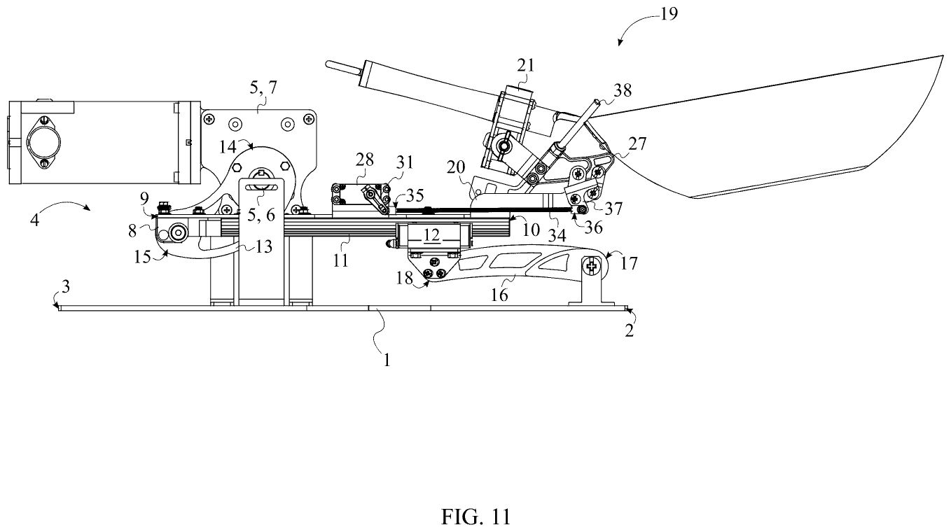

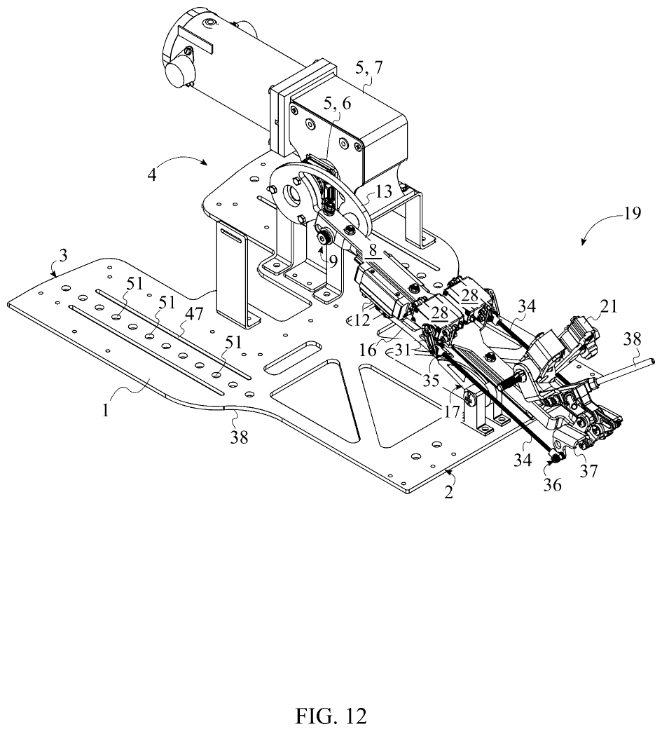

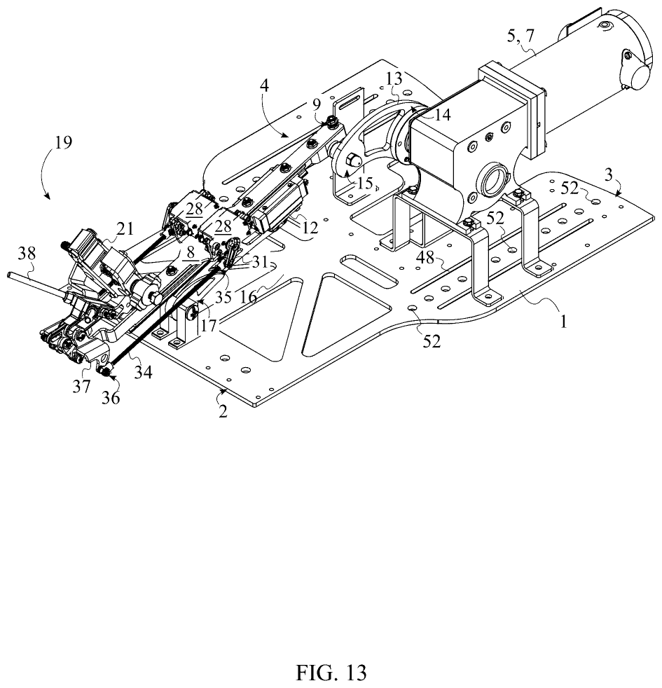

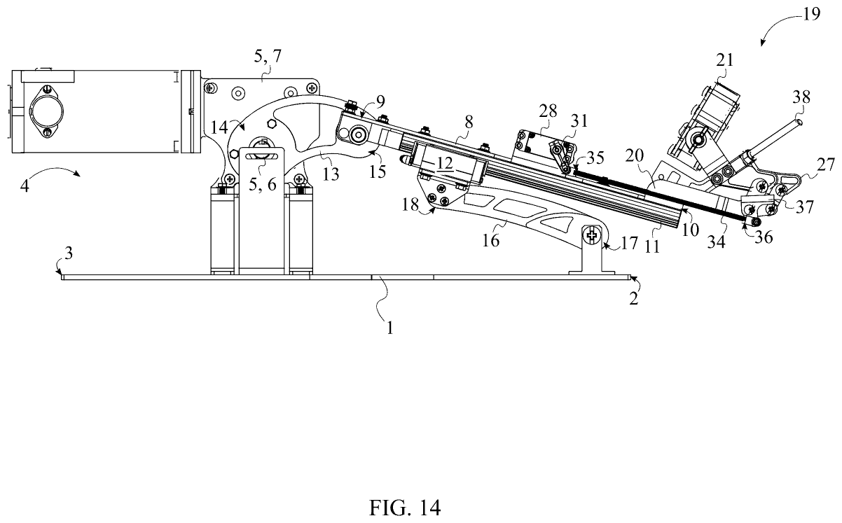

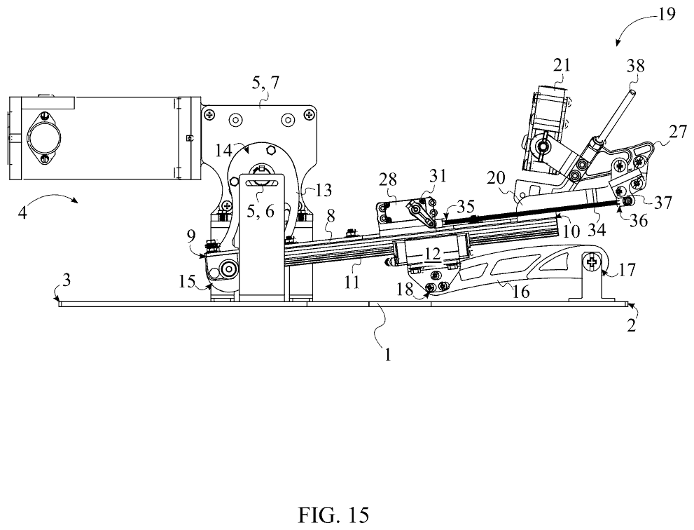

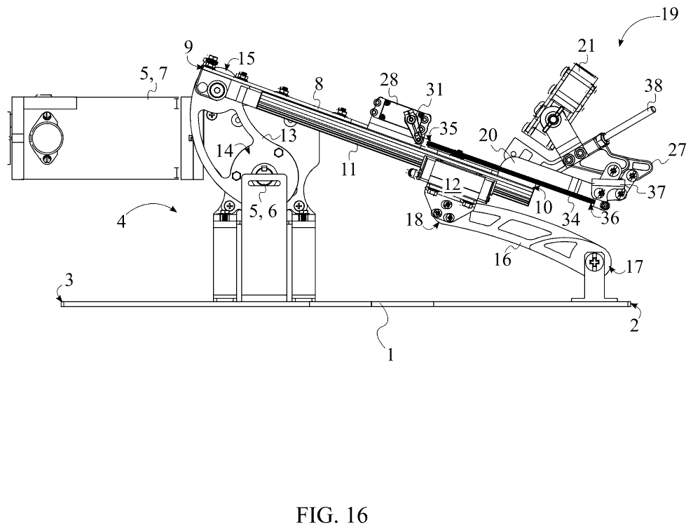

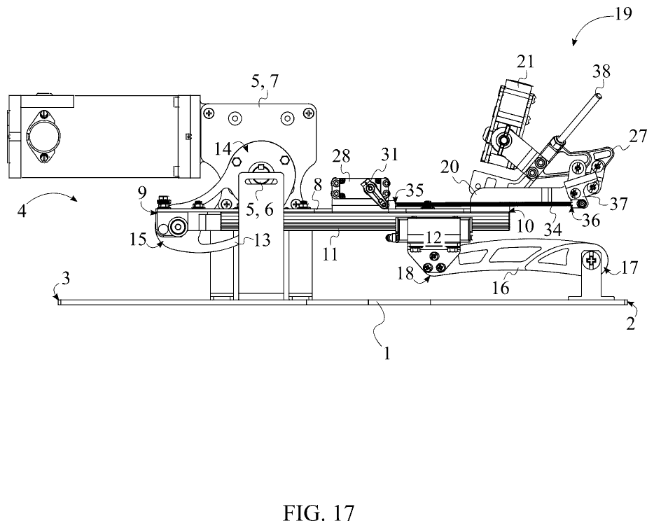

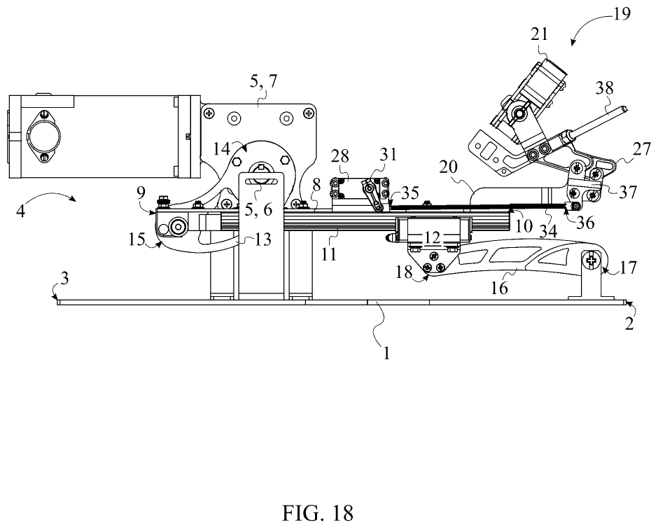

The present invention discloses a portable automated wok agitation system. The present invention facilitates an automated wok pan agitation process, effectively replicating the dexterity and precision exhibited by a professional human wok chef. The present invention consistently and uniformly mixes the food products within the wok, ensuring thorough integration and even heat distribution of the food products, thereby enhancing the overall culinary experience. As can be seen in FIG. 1 through 18 and 30, the present invention comprises a mounting plate 1, a motorized arm assembly 4, a motorized wrist assembly 19, a controller 39, and a portable power source 40. The mounting plate 1 serves as the supporting base for the moving components of the present invention and facilitates the mounting of the present invention to the desired wok range. The motorized arm assembly 4 serves to generate the “arm” movements required to properly agitate the wok during the cooking process. The motorized wrist assembly 19 generates the “wrist” movements required to properly flip and move the food products in the wok during the cooking process. The motorized wrist assembly 19 also supports the desired wok in the proper orientation above the wok range. The controller 39 facilitates the automated operation of the motorized arm assembly 4 and the motorized wrist assembly 19. The portable power source 40 provides the electrical power necessary for the automated operation of the present invention.

The general configuration of the aforementioned components along with the application of machine learning delivers a robust, efficient, and automated wok cooking experience that can mimic the intricate movements of professional chefs. As previously discussed, the motorized arm assembly 4 is designed to mimic the arm movement of professional chefs to agitate the wok, and the food products contained by the wok, during the cooking process. As can be seen in FIG. 1 through 18 and 30, the motorized arm assembly 4 preferably includes an inverted slider crank mechanism that facilitates the gross trajectory profile of the wok during the cooking process. So, the motorized arm assembly 4 comprises an arm motor 5, a connecting arm 8, a guiding rail 11, a sliding carriage 12, an arm crank 13, and a rocker link 16. The arm motor 5 is preferably a Direct Current (DC) gearmotor that drives the motorized arm assembly 4. The connecting arm 8 is an elongated thin structure that connects the moving components of the motorized arm assembly 4 together. The connecting arm 8 comprises a proximal arm end 9 and a distal arm end 10 corresponding to the terminal ends of the connecting arm 8.

As can be seen in FIG. 1 through 18 and 30, the guiding rail 11 further enables the controlled linear movement of the sliding carriage 12 along the connecting arm 8. The arm crank 13 serves to convert the rotational motion generated by the arm motor 5. The rocker link 16 supports the unobstructed oscillating linear movement of the connecting arm 8. In addition, the rocker link 16 comprises a pivoting link end 17 and a fixed link end 18 corresponding to the terminal ends of the rocker link 16. Further, the mounting plate 1 is preferably an elongated flat structure large enough to accommodate the moving components of the motorized arm assembly 4 and the motorized wrist assembly 19. The mounting plate 1 comprising a front edge 2 and a rear edge 3 corresponding to two opposite lateral edges of the mounting plate 1. Furthermore, the arm motor 5 comprises an arm rotor 6 and an arm stator 7 corresponding to the moving and stational components of the arm motor 5, respectively.

In general, the present invention can be arranged as follows: the arm stator 7 is mounted onto the mounting plate 1, adjacent to the rear edge 3, to secure the arm motor 5 to the mounting plate 1. As can be seen in FIG. 1 through 18 and 30, the pivoting link end 17 is also pivotally connected to the mounting plate 1, adjacent to the front edge 2, to secure the rocker link 16 to the mounting plate 1 while enabling the rocker link 16 to pivot on the mounting plate 1. Further, the proximal arm end 9 is torsionally connected to the arm rotor 6 by the arm crank 13 so that the connecting arm 8 is moved linearly by the arm crank 13 rotated by the arm motor 5. The guiding rail 11 is also positioned parallel to the connecting arm 8 so that the guiding rail 11 is aligned to the connecting arm 8. Further, the guiding rail 11 is mounted along the connecting arm 8 to secure the guiding rail 11 to the connecting arm 8. In addition, the sliding carriage 12 is slidably mounted along the guiding rail 11 so that the sliding carriage 12 can linearly move along the connecting arm 8 in a limited range. For example, the guiding rail 11 can span the length of the connecting arm 8, or just a section of the connecting arm 8.

As can be seen in FIG. 1 through 18 and 30, the fixed link end 18 is further connected to the sliding carriage 12, opposite the connecting arm 8, to secure the rocker link 16 to the sliding carriage 12. This way, the moving connecting arm 8 can follow the desired oscillating linear movement without getting off track. In addition, the motorized wrist assembly 19 is mounted onto the connecting arm 8, adjacent to the distal arm end 10, to secure the wrist assembly to the connecting arm 8. As a result, the motorized wrist assembly 19, and the support wok, is moved along the trajectory generated by the movement of the connecting arm 8. Furthermore, the arm motor 5 is electronically connected to the controller 39 and is electrically connected to the portable power source 40 to enable the automated operation of the present invention. In other embodiments, the present invention can be modified to accommodate different cooking utensils to cook different food products using different cooking methods. The present invention can be configured to accommodate other cooking pans with an elongated handle from which the cooking pan can be attached to the motorized wrist assembly 19. Further, the present invention can be modified to be mounted onto different residential and/or commercial cooking ranges.

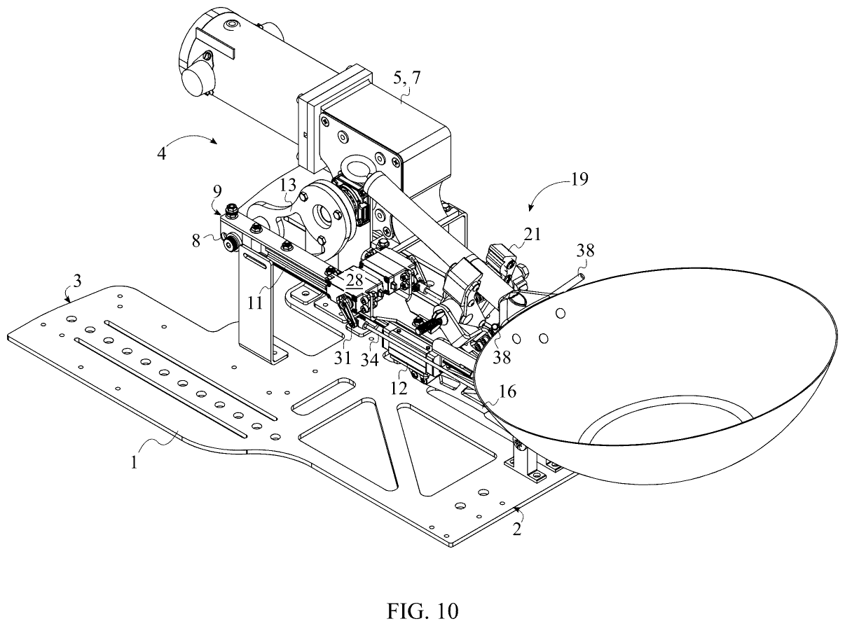

As previously discussed, the arm crank 13 enables the conversion of the rotational motion of the arm crank 13 driven by the arm motor 5 into the oscillating linear motion of the connecting arm 8. As can be seen in FIG. 10 through 18, 23, and 24, the arm crank 13 is preferably a curved tear-shaped flat structure with the dimensions necessary to generate the desired trajectories. The arm crank 13 comprises a first crank end 32 14 and a second crank end 33 15 corresponding to the terminal ends of the arm crank 13. Due to the overall design of the arm crank 13, the first crank end 32 14 is positioned opposite to the second crank end 33 15 along the arm crank 13. In addition, the first crank end 32 14 of the arm crank 13 is torsionally connected to the arm rotor 6 so that the arm motor 5 drives the rotation of the arm crank 13. Further, the second crank end 33 15 of the arm crank 13 is pivotally connected to the proximal arm end 9 to connect the arm crank 13 to the connecting arm 8. In other embodiments, different designs for the arm crank 13 can be implemented to generate different trajectories of the connecting arm 8.

To facilitate the automated operation of the motorized arm assembly 4, the present invention may further comprise an angle sensor 41 that enables the automated monitoring of the rotation, and the angular positioning of the arm crank 13. As can be seen in FIG. 10 through 18, 23, and 24, the angle sensor 41 is operatively connected to the first crank end 32 14 of the arm crank 13, wherein the angle sensor 41 is used to track the angular movement and positioning of the arm crank 13 being rotated by the arm motor 5. For example, the angle sensor 41 can be provided in a corresponding housing that enables the angle sensor 41 to be integrated on the connection between the arm motor 5 and the arm crank 13. Furthermore, the angle sensor 41 is electronically connected to the controller 39 and is electrically connected to the portable power source 40. This way, the electrical signals generated by the angle sensor 41 can be transmitted to the controller 39 for processing, and the portable power source 40 provides the electrical power necessary for the operation of the angle sensor 41.

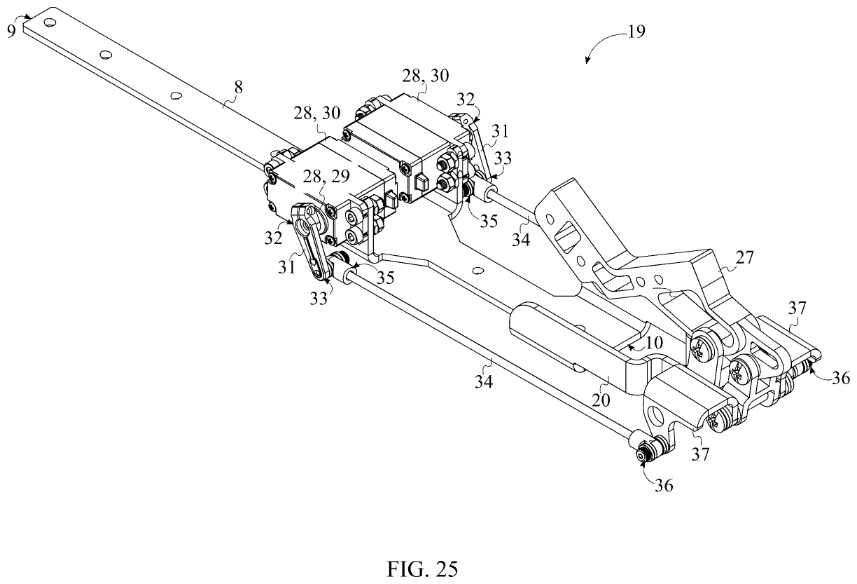

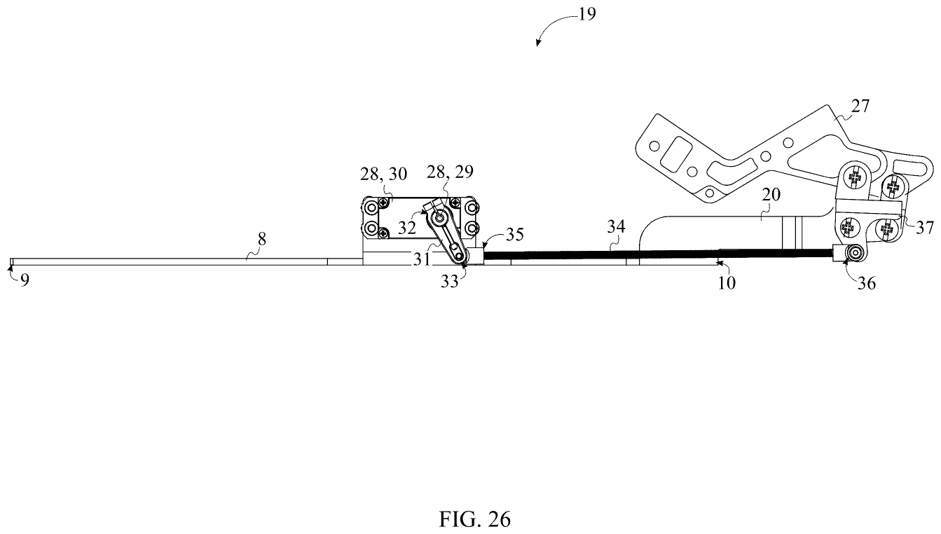

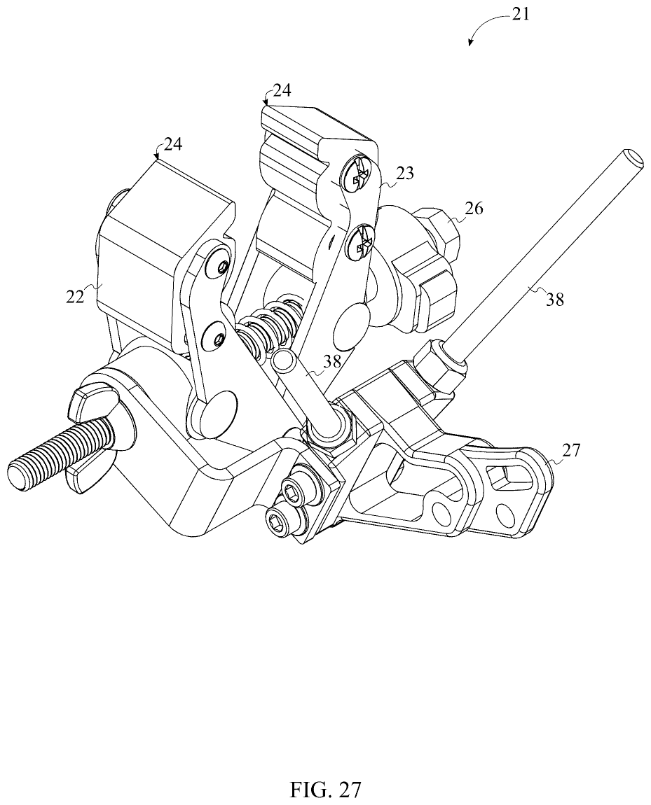

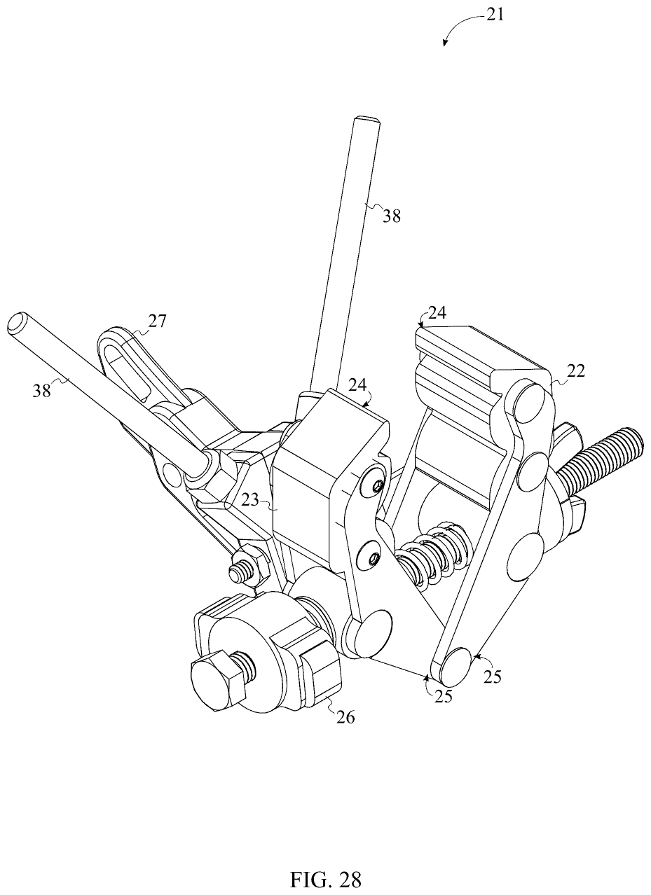

As previously discussed, the motorized wrist assembly 19 generates the wrist motions necessary to move the wok and the ingredients in the wok during the cooking process. In addition, the motorized wrist assembly 19 enables the desired wok to be secured to the present invention in the desired orientation above the wok range. As can be seen in FIG. 10 through 18 and 25 through 28, the motorized wrist assembly 19 comprises a clamp mount 20, an adjustable jaw clamp 21, and a propping bracket 27. The clamp mount 20 serves to connect the adjustable jaw clamp 21 to the connecting arm 8 in the proper positioning. The adjustable jaw clamp 21 facilitate the connection of the wok to the motorized wrist assembly 19 in an easy manner that also allows for quick detachment of the wok. The propping bracket 27 allows the positioning of the wok on the motorized wrist assembly 19 in the proper orientation above the wok range during the agitation process.

In the preferred embodiment, the motorized wrist assembly 19 can be arranged as follows: the clamp mount 20 is terminally mounted onto the distal arm end 10 to position the clamp mount 20 opposite to the arm crank 13. As can be seen in FIG. 10 through 18 and 25 through 28, the propping bracket 27 is also oriented perpendicular to the connecting arm 8 to allow for the unobstructed movement of the propping bracket 27 on the clamp mount 20. The propping bracket 27 is preferably a “Z” shaped flat bracket that pivots on the clamp mount 20. The propping bracket 27 is pivotally connected to the clamp mount 20, offset to the distal arm end 10, so that the propping bracket 27 can pivot on the clamp mount 20. The pivot connection is preferably positioned at the center of the propping bracket 27 so that the propping bracket 27 can move on pivot on the clamp mount 20 in a seesaw-like manner. In addition, the end of the propping bracket 27 positioned away from the connecting arm 8 serves to support the lateral wall of the wok, while the end of the propping bracket 27 positioned towards the connecting arm 8 moves freely. Further, the adjustable jaw clamp 21 is oriented perpendicular to the propping bracket 27 so that the wok's handle is oriented parallel to the connecting arm 8 once the wok's handle is secured to the adjustable jaw clamp 21. The adjustable jaw clamp 21 is also mounted onto the propping bracket 27, adjacent to the distal arm end 10. This way, when the propping bracket 27 tilts forward away from the connecting arm 8, the adjustable jaw clamp 21 is elevated, which tilts the wok downward. Likewise, when the propping bracket 27 tilts backward toward the connecting arm 8, the adjustable jaw clamp 21 is lowered, which tilts the wok upward. In other embodiments, the motorized wrist assembly 19 can be altered to support different cooking utensils.

As previously discussed, the adjustable jaw clamp 21 is designed to enable the easy mounting of the wok to the present invention as well as to enable the quick release of the wok during or after the cooking process. As can be seen in FIG. 10 through 18 and 25 through 28, the adjustable jaw clamp 21 is preferably an upright Dimide clamp with a quick-release handle that secures the wok's handle to the motorized wrist assembly 19. So, the adjustable jaw clamp 21 may comprise a first jaw 22, a second jaw 23, and a quick-release fastener 26. The first jaw 22 and the second jaw 23 correspond to the gripping portions of the adjustable jaw clamp 21, while the quick-release fastener 26 enables the adjustable and releasable fastening of the first jaw 22 to the second jaw 23. The first jaw 22 and the second jaw 23 are preferably to curved structures with internal gripping features that secure the wok's handle between the first jaw 22 and the second jaw 23. Further, the first jaw 22 and the second jaw 23 each comprises a free jaw end 24 and a hinged jaw end 25 corresponding to the terminal ends of each jaw.

In the preferred embodiment, the adjustable jaw clamp 21 can be arranged as follows: the free jaw end 24 is oriented away from the connecting arm 8 while the hinged jaw end 25 is oriented towards the connecting arm 8 to orient each jaw in an upright position above the connecting arm 8. As can be seen in FIG. 10 through 18 and 25 through 28, the hinged jaw end 25 of the first jaw 22 is hingedly connected to the hinged jaw end 25 of the second jaw 23 to form an adjustable clamp structure that receives a portion of the wok's handle and positions the wok's handle parallel to the connecting arm 8. Further, the first jaw 22 is mounted onto the propping bracket 27 so that the pivoting movement of the propping bracket 27 moves the adjustable jaw clamp 21 accordingly. Furthermore, the second jaw 23 is laterally connected to the first jaw 22 by the quick-release fastener 26 so that the quick release fastener maintains the first jaw 22 and the second jaw 23 connected to each other. The quick-release fastener 26 is preferably a spring-loaded fastener with a lock that can be selectively disengaged by the user to release the first jaw 22 form the second jaw 23. When the user places the wok's handle in between the first jaw 22 and the second jaw 23, the user presses the first jaw 22 and the second jaw 23 against the wok's handle to securely close the adjustable jaw clamp 21 on the wok's handle. The lock of the quick-release fastener 26 keeps the adjustable jaw clamp 21 closed, and only when the user releases the lock, then the user can remove the wok's handle from the adjustable jaw clamp 21. In other embodiments, the adjustable jaw clamp 21 can be modified to accommodate different handle designs of other cooking pans.

As can be seen in FIG. 10 through 18, 25 through 28, and 30, to facilitate the automated operation of the motorized wrist assembly 19, the wrist assembly may further comprise at least one servomotor 28, at least one servo crank 31, at least one wrist rod 34, and at least one pivoting bracket 37. The at least one servomotor 28 enables the fine-tuning motions about the gross trajectory of the connecting arm 8. In other words, the at least one servomotor 28 drives the seesaw-like motion of the propping bracket 27 that moves the adjustable jaw clamp 21 and the retained wok's handle that mimic a chef's wrist motions that compensate the slight variations of the wok agitation process. The at least one servo crank 31, the at least one wrist rod 34, and the at least one pivoting bracket 37 enable the connection of the at least one servomotor 28 to the propping bracket 27 in such a way that the rotational motion of the at least one servo crank 31 is converted into the seesaw-like motion of the propping bracket 27. Further, like the arm motor 5, the at least one servomotor 28 comprises a servo rotor 29 and a servo stator 30 corresponding to the moving portion and the stationary portion of the at least one servomotor 28. In addition, the at least one wrist rod 34 comprises a proximal rod end 35 and a distal rod end 36 corresponding to the opposite terminal ends of the at least one wrist rod 34.

In the preferred embodiment, the at least one servomotor 28 can be implemented as follows: the servo stator 30 is positioned opposite to the guiding rail 11 across the connecting arm 8 to position the at least one servomotor 28 above the connecting arm 8. As can be seen in FIG. 10 through 18, 25 through 28, and 30, the servo stator 30 is also mounted onto the connecting arm 8, offset to the distal arm end 10, to secure the at least one servomotor 28 to the connecting arm 8. The distance of the at least one servomotor 28 to the distal arm end 10 matches the working length of the at least one wrist rod 34. Further, the proximal rod end 35 is torsionally connected to the servo rotor 29 by the servo crank to convert the rotational motion of the at least one servo crank 31 driven by the at least one servomotor 28 into an oscillating linear motion of the at least one wrist rod 34. In addition, the distal rod end 36 is pivotally connected to the propping bracket 27 by the at least one pivoting bracket 37. The at least one pivoting bracket 37 offsets the distal rod end 36 from the propping bracket 27 in such a way that the oscillating linear motion of the at least one wrist rod 34 drives the seesaw-like motion of the propping bracket 27. Furthermore, the at least one servomotor 28 is electronically connected to the controller 39 and is electrically connected to the portable power source 40 to fully automate the operation of the motorized wrist assembly 19. In other embodiments, the at least one servomotor 28 can be altered to drive different motion trajectories of the adjustable jaw clamp 21.

Similar to the arm crank 13, the at least one servo crank 31 is designed to facilitate the controlled conversion of rotational motion into oscillating linear motion that drives the desired movement trajectory of the motorized wrist assembly 19. As can be seen in FIG. 10 through 18, 25 through 28, and 30, the at least one servo crank 31 may be an elongated flat component comprising a first crank end 32 14 and a second crank end 33 15 corresponding to the terminal ends of the at least one servo crank 31. To implement the at least one servo crank 31, the first crank end 32 14 is positioned opposite to the second crank end 33 15 along the at least one servo crank 31 due to the elongated design of the at least one servo crank 31. Further, the first crank end 32 14 of the at least one servo crank 31 is torsionally connected to the servo rotor 29 so that the at least one servomotor 28 drives the rotation of the at least one servo crank 31. In addition, the second crank end 33 15 of the at least one servo crank 31 is pivotally connected to the proximal rod end 35 so that the rotational motion of the at least one servo crank 31 is converted into oscillating linear motion of the at least one wrist rod 34. In other embodiments, the at least one servo crank 31 may be modified to facilitate the generation of different motion trajectories for the motorized wrist assembly 19.

In general, the wok's handle has a tubular elongated design that may twist during the agitation process if the wok's handle is not gripped properly. As can be seen in FIG. 10 through 18, 25 through 28, and 30, to avoid twisting of the wok when mounted onto the adjustable jaw clamp 21, the motorized wrist assembly 19 may further comprise a pair of stabilizing rods 38 that keeps the wok vertically aligned with the connecting arm 8. Along with the end of the propping bracket 27, the pair of stabilizing rods 38 forms a three-point contact wherein the end of the propping bracket 27 contacts the wok's lateral wall below the wok's handle, and the pair of stabilizing rods 38 contacts the wok's rim on opposite sides of the wok's handle. To do so, the pair of stabilizing rods 38 is positioned opposite to each other across the propping bracket 27 to provide lateral support to the wok across the wok's handle. In addition, each stabilizing rod of the pair of stabilizing rods 38 is oriented away from the mounting plate 1 so that the pair of stabilizing rods 38 contacts the wok's lateral wall when the wok's handle is gripped by the adjustable jaw clamp 21. Further, each stabilizing rod of the pair of stabilizing rods 38 is oriented at an acute angle with the propping bracket 27 to form a triangular structure that provides stable support to the wok. Furthermore, each of the pair of stabilizing rods 38 is terminally connected to the propping bracket 27, adjacent to the adjustable jaw clamp 21, to secure the pair of stabilizing rods 38 to the propping bracket 27. In other embodiments, different support mechanisms may be integrated to support the wok during the automated cooking process.

As previously discussed, the present invention is provided as a portable system that can be mounted onto the desired wok range for automated agitation of the attached wok during the cooking process. As can be seen in FIG. 1 through 9, 19, and 20, to facilitate the mounting of the system to a wok range, the present invention may further comprise a mounting clamp assembly 42. The mounting clamp assembly 42 is designed to facilitate the mounting of the system to wok range while also allowing the system to be properly aligned on the wok range. To do so, the mounting clamp assembly 42 comprises a first clamp bracket 43, a second clamp bracket 44, at least one first guide groove 47, at least one second guide groove 48, a first bracket rail 49, and a second bracket rail 50. The first clamp bracket 43 and the second clamp bracket 44 correspond to two of the main components of a dual-action clamp that can either clamp the mounting plate 1 to the bottom of the range deck or “pinch” the range deck from the front and back, depending on the preferred orientation. The at least one first guide groove 47, the at least one second side groove, the first bracket rail 49, and the second bracket rail 50 allow the vertical displacement of the mounting plate 1 on the mounting clamp assembly 42. Further, the first clamp bracket 43 and the second clamp bracket 44 are preferably two elongated, overall curved bracket structures. The first clamp bracket 43 and the second clamp bracket 44 each also comprises a first bracket end 45 corresponding to the terminal end of each clamp bracket that engages the corresponding bracket rail.

In the preferred embodiment, the mounting clamp assembly 42 can be arranged as follows: the at least one first guide groove 47, the at least one second guide groove 48, the first bracket rail 49, and the second bracket rail 50 are each positioned parallel to the connecting arm 8. As can be seen in FIG. 1 through 9, 19, and 20, the at least one first guide groove 47 and the at least one second guide groove 48 are also positioned opposite to each other across the motorized arm assembly 4 to form a symmetric structure along the longitudinal axis of the mounting plate 1. Further, the first bracket rail 49 is mounted onto the mounting plate 1, adjacent to the at least one first guide groove 47, to secure the first bracket rail 49 to the upper surface of the mounting plate 1. Likewise, the second bracket rail 50 is mounted onto the mounting plate 1, adjacent to the at least one second guide groove 48, to also secure the second bracket rail 50 to the upper surface of the mounting plate 1. Further, the first clamp bracket 43 and the second clamp bracket 44 are positioned opposite to the motorized arm assembly 4 across the mounting plate 1 so that the first clamp bracket 43 and the second clamp bracket 44 are positioned below the lower surface of the mounting plate 1. In addition, the first bracket end 45 of the first clamp bracket 43 is slidably mounted along the first bracket rail 49 through the at least one first guide groove 47 so that the first clamp bracket 43 can be linearly moved along the first bracket rail 49. Likewise, the first bracket end 45 of the second clamp bracket 44 is slidably mounted along the second bracket rail 50 through the at least one second guide groove 48 so that the second clamp bracket 44 can also be linearly moved along the second bracket rail 50.

As can be seen in FIG. 1 through 9, 19, and 20, the first clamp bracket 43 and the second clamp bracket 44 can be locked into position along the first bracket rail 49 and the second bracket rail 50, respectively, to adjust the overall horizontal position of the system relative to the mounting clamp assembly 42. To do so, the mounting clamp assembly 42 may further comprise a plurality of first plunger orifices 51, a plurality of second plunger orifices 52, a first locking plunger 53, a second locking plunger 54, a first plunger bracket 55, and a second plunger bracket 56. The first locking plunger 53 and the second locking plunger 54 enable the user to lock the first clamp bracket 43 and the second clamp bracket 44 into the desired position along the first bracket rail 49 and the second bracket rail 50, respectively. The plurality of first plunger orifices 51 and the plurality of second plunger orifices 52 enables the engagement of the first locking plunger 53 and the second locking plunger 54 with the first bracket rail 49 and the second bracket rail 50, respectively. Further, the first plunger bracket 55 and the second plunger bracket 56 enable the mounting of the first locking plunger 53 and the second locking plunger 54 to the first clamp bracket 43 and the second clamp bracket 44, respectively.

In the preferred embodiment, the first locking plunger 53 and the second locking plunger 54 may be implemented as follows: the plurality of first plunger orifices 51 is distributed along the first bracket rail 49 to evenly distribute the plurality of first plunger orifices 51 along the first bracket rail 49. As can be seen in FIG. 1 through 9, 19, and 20, each of the plurality of first plunger orifices 51 also traverses through the mounting plate 1 and into the first bracket rail 49 to enable the first locking plunger 53 to engage with the first bracket rail 49 through the mounting plate 1. Similarly, the plurality of second plunger orifices 52 is distributed along the second bracket rail 50 to evenly distribute the plurality of second plunger orifices 52 along the second bracket rail 50. In addition, each of the plurality of second plunger orifices 52 traverses through the mounting plate 1 and into the second bracket rail 50 to enable the second locking plunger 54 to engage with the second bracket rail 50 through the mounting plate 1.

As can be seen in FIG. 1 through 9, 19, and 20, the first locking plunger 53 and the second locking plunger 54 are preferably spring-loaded plungers with a knob that enables the user to engage and/or disengage the desired locking plunger. To align the first locking plunger 53 with the plurality of first plunger orifices 51, the first locking plunger 53 is mounted onto the first clamp bracket 43 by the first plunger bracket 55, offset to the corresponding first bracket end 45. Similarly, the second locking plunger 54 is mounted onto the second clamp bracket 44 by the second plunger bracket 56, offset to the corresponding first bracket end 45, to align the second locking plunger 54 with the plurality of second plunger orifices 52. Further, the first locking plunger 53 is engaged into a selected first plunger orifice from the plurality of first plunger orifices 51 to lock the position of the first clamp bracket 43 along the first bracket rail 49. Likewise, the second locking plunger 54 is engaged into a selected second plunger orifice from the plurality of second plunger orifices 52 to lock the position of the second clamp bracket 44 along the second bracket rail 50. This way, the user can adjust the position of the first clamp bracket 43 and the second clamp bracket 44 to adjust the linear position of the system relative to the mounting clamp assembly 42. The first clamp bracket 43 and the second clamp bracket 44 are moved symmetrically to adjust the position of the system. In other embodiments, different mechanisms can be implemented to adjust the non-linear position of the system relative to the mounting clamp assembly 42.

As can be seen in FIG. 1 through 9, 19, and 20, to facilitate the engagement of the mounting clamp assembly 42 with the wok range, the mounting clamp assembly 42 may further comprise a first V-shaped arm 57, a second V-shaped arm 58, a first clamp rod 62, a second clamp rod 63, a leadscrew 64, and a threaded hole 67. The first V-shaped arm 57 and the second V-shaped arm 58 enable the mounting clamp assembly 42 to engage with the lateral walls of the wok range to secure the system's position on the wok range. In addition, the first V-shaped arm 57 and the second V-shaped arm 58 each comprises a first arm end 59, an arm elbow 60, and a second arm end 61. The first arm end 59 and the second arm end 61 correspond to the terminal ends of each V-shaped arm, while the arm elbow 60 corresponds to the sharp peak of the V-shaped arm. The first clamp bracket 43 and the second clamp bracket 44 may each further comprise a second bracket end 46 corresponding to the other terminal end of each clamp bracket that is oriented away from the mounting plate 1.

As can be seen in FIG. 1 through 9, 19, and 20, to implement the first V-shaped arm 57 and the second V-shaped arm 58, the first clamp bracket 43 and the second clamp bracket 44 are each oriented towards the rear edge 3 so that the first clamp bracket 43 and the second clamp bracket 44 are oriented away from the wok range. On the other hand, the first V-shaped arm 57 and the second V-shaped arm 58 are each oriented towards the rear edge 3 so that the first V-shaped arm 57 and the second V-shaped arm 58 are oriented towards the wok range. Further, the first clamp rod 62 is terminally and rotatably connected in between the second bracket end 46 of the first clamp bracket 43 and the second bracket end 46 of the second clamp bracket 44. This way, the linear displacement of the first clamp rod 62 also moves the first clamp bracket 43 and the second clamp bracket 44 while enabling the first clamp rod 62 to freely rotate. In addition, the first arm end 59 of the first V-shaped arm 57 is hingedly connected to the first clamp bracket 43, adjacent to the corresponding first bracket end 45, to secure the first V-shaped arm 57 to the first clamp bracket 43. Similarly, the first arm end 59 of the second V-shaped arm 58 is hingedly connected to the second clamp bracket 44, adjacent to the corresponding first bracket end 45, to secure the second V-shaped arm 58 to the second clamp bracket 44. Further, similar to the first clamp rod 62, the second clamp rod 63 is terminally and rotatably connected in between the arm elbow 60 of the first V-shaped arm 57 and the arm elbow 60 of the second V-shaped arm 58. This way, the linear displacement of the second clamp rod 63 also moves the first V-shaped arm 57 and the second V-shaped arm 58 together while enabling the second clamp rod 63 to freely rotate.

As can be seen in FIG. 1 through 9, 19, and 20, the threaded hole 67 further traverses through the first clamp rod 62 and through the second clamp rod 63 to accommodate the leadscrew 64. The threaded openings formed on the first clamp rod 62 and the second clamp rod 63 by the threaded hole 67 are preferably aligned with each other so that the leadscrew 64 can be threadably engaged into the threaded hole 67. The threading of the threaded hole 67 is preferably female threading, while the threading on the leadscrew 64 is the corresponding male threading. This way, as the leadscrew 64 is engaged into the threaded hole 67, the second clamp rod 63 is moved towards the first clamp rod 62, which in turn moves the first V-shaped arm 57 and the second V-shaped arm 58 towards the first clamp bracket 43 and the second clamp bracket 44, respectively. On the other hand, as the leadscrew 64 is disengaged from the threaded hole 67, the second clamp rod 63 is moved away from the first clamp rod 62, which in turn moves the first V-shaped arm 57 and the second V-shaped arm 58 away from the first clamp bracket 43 and the second clamp bracket 44, respectively.

In the preferred embodiment, the leadscrew 64 is preferably manually engaged by the user. As can be seen in FIG. 1 through 9, 19, and 20, to enable the manual engagement of the leadscrew 64, the leadscrew 64 may comprise a screw handle 65 and a threaded body 66. The threaded body 66 corresponds to the main structure of the leadscrew 64 that engages the threaded hole 67. The screw handle 65 corresponds to the portion of the leadscrew 64 that the user can manually engage to drive the leadscrew 64. In general, the screw handle 65 is positioned external to the threaded hole 67 and is positioned adjacent to the rear edge 3 to facilitate access to the user. Further, the threaded body 66 is threadably engaged into the threaded hole 67 to fasten the leadscrew 64 into the threaded hole 67. In other embodiments, a motorized mechanism can be implemented that allows the automated configuration of the mounting clamp assembly 42 by the controller 39 according to user input and/or environmental sensor data.

As previously discussed, each V-shaped arm is designed to engage with a lateral surface of the wok range. As can be seen in FIG. 1 through 9, 19, and 20, to facilitate the safe engagement of each V-shaped arm with the wok range, the mounting clamp assembly 42 may further comprise a first contact knob 68 and a second contact knob 69. The first contact knob 68 and the second contact knob 69 correspond to two pivoting structures that safely engage the lateral surfaces of the wok range. To do so, the first contact knob 68 is pivotally connected to the second arm end 61 of the first V-shaped arm 57 to secure the first contact knob 68 to the first V-shaped arm 57 while enabling the first contact knob 68 to pivot about the corresponding second arm end 61. Similarly, the second contact knob 69 is pivotally connected to the second arm end 61 of the second V-shaped arm 58 to secure the second contact knob 69 to the second V-shaped arm 58 while enabling the second contact knob 69 to pivot about the corresponding second arm end 61. In other embodiments, different mechanisms can be implemented to help the mounting clamp assembly 42 engage with different portions of the wok range.

As can be seen in FIG. 1 through 9, in addition to the mounting clamp assembly 42, the present invention may further comprise a first rear leg 70 and a second rear leg 71 that allow the system to be supported from a flat surface or external object. The first rear leg 70 and the second rear leg 71 also enable the user to safely move the system when desired. To do so, the first rear leg 70 and the second rear leg 71 are each oriented perpendicular to the mounting plate 1 to position the first rear leg 70 and the second rear leg 71 vertically. In addition, the first rear leg 70 and the second rear leg 71 are positioned parallel and offset to each other along the rear edge 3. The first rear leg 70 and the second rear leg 71 are preferably positioned on the rear corners of the mounting plate 1; however, different arrangements can be implemented for better support to the mounting plate 1. Further, the first rear leg 70 and the second rear leg 71 are terminally mounted onto the mounting plate 1, opposite to the motorized arm assembly 4, to secure the first rear leg 70 and the second rear leg 71 to the mounting plate 1 to the lower surface of the mounting plate 1.

As can be seen in FIG. 1 through 9, the present invention may further comprise a first front leg 72, a second front leg 73, and a leg crossbar 75. Like the first rear leg 70 and the second rear leg 71, the first front leg 72 and the second front leg 73 provide frontal support to the mounting plate 1. However, the first front leg 72 and the second front leg 73 can be adjusted to accommodate non-vertical surfaces of the wok range or other structure upon which the system is placed. The first front leg 72 and the second front leg 73 each comprises a hinged leg end 74 corresponding to the end of each front leg that is connected to the mounting plate 1. To do so, the first front leg 72 and the second front leg 73 are positioned parallel and offset to each other along the front edge 2. Like the first rear leg 70 and the second rear leg 71, the first front leg 72 and the second front leg 73 are positioned on the front corners of the mounting plate 1. Further, the leg crossbar 75 is terminally connected in between the first front leg 72 and the second front leg 73, offset from the hinged leg end 74 of the first front leg 72 and the hinged leg end 74 of the second front leg 73. This way, both front legs can be moved together when the user moves either one of the front legs.

As can be seen in FIG. 1 through 9, the hinged leg end 74 of the first front leg 72 is also hingedly connected to the mounting plate 1, opposite to the motorized wrist assembly 19, to secure the first front leg 72 to the lower surface of the mounting plate 1. Likewise, the hinged leg end 74 of the second front leg 73 is also hingedly connected to the mounting plate 1, opposite to the motorized wrist assembly 19, to secure the second front leg 73 to the lower surface of the mounting plate 1. Furthermore, the first front leg 72 and the second front leg 73 may both include a layer of heat-resistant material (e.g., neoprene) that prevents heat from damaging the components of the system. The layer of heat-resistant material is preferably positioned on the surface of each front leg that faces the surfaces of the wok range. In alternate embodiments, different support structures can be implemented to securely mount the system on the wok range.

In addition to the front legs and the rear legs, the present invention may include means to prevent the system from falling off the wok range while the automatic agitation of the wok is performed by the system during the cooking process. As can be seen in FIG. 1 through 9, 21, and 22, the present invention may further comprise a first dropdown lock 76 and a second dropdown lock 77 that engage with a surface of the wok range adjacent to the burner. To do so, the first dropdown lock 76 and second dropdown lock 77 are positioned parallel and offset to each other along the front edge 2. Like the front legs, the first dropdown lock 76 and the second dropdown lock 77 may be positioned on the front corners of the mounting plate 1. Further, the first dropdown lock 76 and the second dropdown lock 77 are each mounted onto the mounting plate 1, offset to the motorized wrist assembly 19, to secure the first dropdown lock 76 and the second dropdown lock 77 to the upper surface of the mounting plate 1.

As can be seen in FIG. 1 through 9, 21, and 22, the first dropdown lock 76 and the second dropdown lock 77 are preferably designed to be manually engaged by the user when mounting the system onto the wok range. In some embodiments, the first dropdown lock 76 and the second dropdown lock 77 may each comprise a lock base 78, a lock bump 79, a lock bar 80, and a cam lever 81. The lock base 78 corresponds to the base of each dropdown lock that secures the corresponding dropdown lock to the mounting plate 1. The lock bump 79 guides the position of the lock bar 80 about the lock base 78, while the lock bar 80 secures the mounting plate 1 to the target vertical surface of the wok range. Further, the cam lever 81 enables the lockable fastening of the lock bar 80 about the lock base 78. Each dropdown lock can be arranged as follows: the lock base 78 and the lock bar 80 are oriented perpendicular to the mounting plate 1 so that the movement of the lock bar 80 is vertically oriented. The lock base 78 is preferably an overall square structure large enough to offset the lock bar 80 from the mounting plate 1. The lock bar 80 is an elongated rectangular structure long enough to reach and engage the vertical surface of the wok range.

As can be seen in FIG. 1 through 9, 21, and 22, the lock bump 79 is also laterally connected to the lock base 78, opposite to the motorized wrist assembly 19, to limit the pivoting motion of the lock bar 80. The lock bump 79 is preferably an overall flat square protrusion smaller than the lock base 78 positioned on the front lower corner of the lock base 78. Further, the lock bar 80 is terminally and pivotally connected to the lock base 78 by the cam lever 81, adjacent to the lock bump 79. This way, when the lock bar 80 is pivoted upwards, the lock bar 80 is oriented parallel to the mounting plate 1 above the lock bump 79. When the lock bar 80 is pivoted downwards, the lock bar 80 is oriented perpendicular to the mounting plate 1 by the lock bump 79 so that the lock bar 80 engages the vertical surface of the wok range. In other embodiments, different locking mechanisms can be implemented to prevent the system from falling off the wok range or other commercial/residential cooking ranges during the automated cooking process.

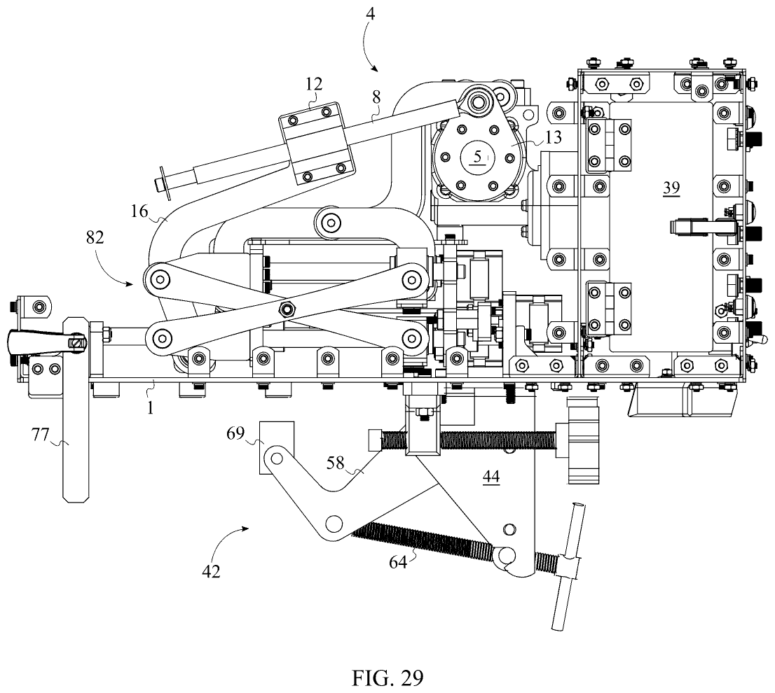

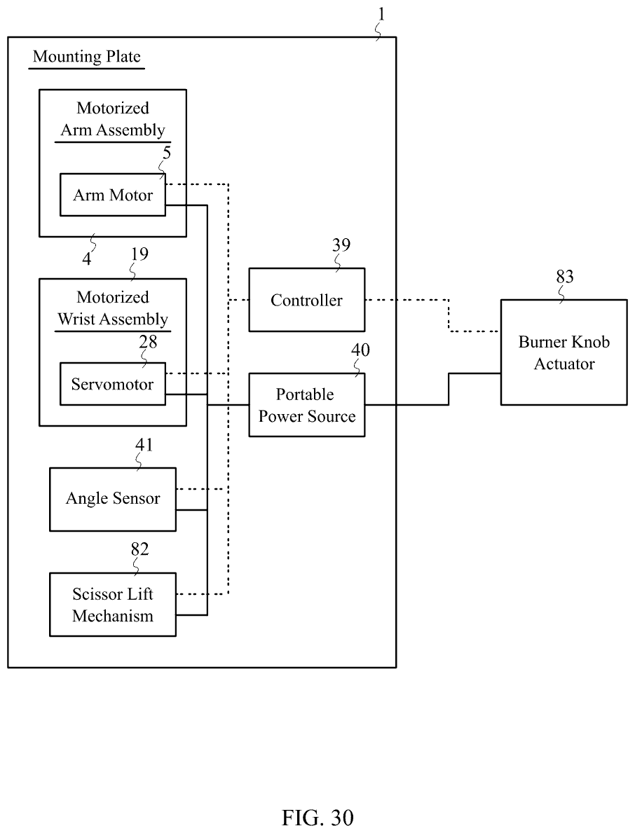

In some embodiments, the present invention enables full adjustment of the system when mounted onto the wok range. The system may need to be elevated to position the wok at a proper distance from the flame. As can be seen in FIGS. 29 and 30, the present invention may further comprise a scissor lift mechanism 82. The motorized arm assembly 4 is operatively mounted onto the mounting plate 1 by the scissor lift mechanism 82, wherein the scissor lift mechanism 82 is used to adjust the vertical position of the motorized arm assembly 4 on the mounting plate 1. For example, the scissor lift mechanism 82 can be mounted onto the upper surface of the mounting plate 1 to secure the scissor lift mechanism 82 to the mounting plate 1. In addition, the arm motor 5 and the rocker link 16 can be mounted onto the scissor lift mechanism 82 accordingly, opposite to the mounting plate 1, to secure the motorized arm assembly 4 and the motorized wrist assembly 19 to the scissor lift mechanism 82. This way, the vertical position of the motorized arm assembly 4 and the motorized wrist assembly 19 can be simultaneously adjusted using the scissor lift mechanism 82. Further, the scissor lift mechanism 82 is electronically connected to the controller 39 and is electrically connected to the portable power source 40 to enable the automated operation of the scissor lift mechanism 82.

In some embodiments, the present invention may further include means to control the operation of different features of the wok range. As can be seen in FIG. 30, the present invention may further comprise at least one burner knob actuator 83 that helps control the flame generated by the corresponding burner on the wok range. The at least one burner know actuator can be a detachable actuator that fits on the burner knob to automatically control the flame intensity that is used to cook the food products on the wok being agitated by the system. The at least one burner knob actuator 83 is positioned offset to the mounting plate 1 so that the at least one burner knob actuator 83 can reach the burner knob on the wok range. Further, the at least one burner knob actuator 83 is electronically connected to the controller 39 and electrically connected to the portable power source 40. For example, the at least one burner knob actuator 83 can be hardwired to the controller 39 and the portable power source 40 for the automated operation of the at least one burner knob actuator 83. Alternatively, the at least one burner knob actuator 83 may be a battery powered actuator that is wirelessly coupled to the controller 39. In other embodiments, different mechanisms can be implemented to control different features or mechanisms of the wok range or other kitchen appliances utilized during the cooking process.

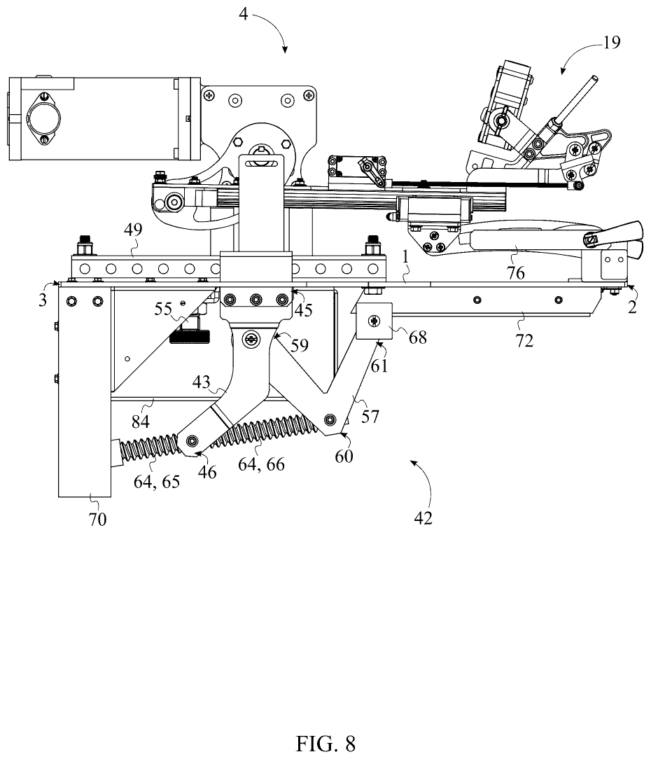

As previously discussed, the system of the present invention is designed as a portable system that is self-contained for case of transportation. As can be seen in FIGS. 8, 9, and 29, the controller 39 and the portable power source 40 can be mounted onto the mounting plate 1 so that the controller 39 and the portable power source 40 are moved along with the mounting plate 1. Special structures can be implemented to house the controller 39 and the portable power source 40 so that the corresponding electrical and electronic components are protected from damage. For example, a power source housing 84 may be implemented to house the portable power source 40 separate from the other components of the system. To do so, the power source housing 84 is centered on the mounting plate 1 to separate the power source housing 84 from the moving components of the mounting clamp assembly 42. In addition, the power source housing 84 is mounted onto the mounting plate 1, opposite to the motorized arm assembly 4, so that the power source housing 84 is secured to the lower surface of the mounting plate 1. Further, the portable power source 40 is mounted within the power source housing 84 to separate the portable power source 40 from the surroundings. The portable power source 40 can be a replaceable battery that can be removed from the power source housing 84 through an access panel on the power source housing 84. Alternatively, the portable power source 40 can be a rechargeable battery that can be recharged within the power source housing 84 through a charging port integrated into the power source housing 84. Furthermore, like the portable power source 40, the controller 39 may also be provided within an electronics housing that protects the controller 39. The electronics housing may include a user interface that allows the user to configure the operational settings of the system that dictate the automated operation of the system. In other embodiments, different structures can be implemented to house different electrical and/or electronic components of the present invention.

In the preferred embodiment, the controller 39 enables the automated control of the movements of the motorized arm assembly 4 and the motorized wrist assembly 19 through various algorithms powered by machine learning. A genetic algorithm can be implemented where each chromosome represents linkage parameters, and fitness is assessed based on the linkage's ability to emulate a human trajectory. The system of the present invention has two degrees of freedom corresponding to the arm movements and the wrist movements generated by the motorized arm assembly 4 and the motorized wrist assembly 19, respectively. The control strategies are developed through a Reinforcement Learning (RL) algorithm and a rule-based control system. Empirically, the rule-based system yields better results due to the limited computational time available, as the rule-based system needs to be trained for each chromosome in the population. Once the present invention is built and real-world data is available, the RL algorithm is trained extensively via transfer learning from simulation.

The RL algorithm employed is proximal policy optimization, where the state includes the arm and wrist angles, the corresponding angular velocities, and the desired trajectory. Actions are defined as the acceleration of the arm crank 13 and the at least one servo crank 31. The reward function is multifaceted and doubles as link configurations genetic algorithms fitness function. The reward function includes: 1) the intersection over union of the desired and resultant trajectories, 2) the velocity profile matching between the desired and resultant trajectories, 3) the distance from the first trajectory point and the last, 4) the energy used for the control, and 5) the intra-distance of the trajectory points. Conversely, the rule-based control method also utilizes these components for determining fitness but does not require a reward function. Instead, the rule-based control method first rigidly sets the wrist and performs a single pass with the arm, then adjusts the wrist up or down sequentially for each point of the resultant trajectory based on whether the desired point is above or below the current position. Once the user inputs the desired action (flip time, flip intensity, and/or number of flips), the cooking process begins and the at least one servomotor 28 interfaces with the burner knob, enabling automated regulation of the flame intensity, and ensuring optimal cooking conditions throughout the stirring and cooking processes.

As a result, the system of the present invention can be implemented using a systematic process for automating wok cooking. The overall process begins by securely attaching the system to the deck of a wok range using the mounting clamp assembly 42. The mounting plate 1 is mounted onto the deck of the wok range and the mounting clamp assembly 42 is engaged to properly position the system on the wok range. In addition, the at least one burner knob actuator 83 is attached to the burner knob for automated flame intensity control. Then, the desired wok is positioned above the corresponding burner by mounting the wok to the motorized wrist assembly 19 using the adjustable jaw clamp 21, thus ensuring optimal heat distribution on the wok. Further, the user can configure the desired settings including, but not limited to, cooking duration, wok motion intensity, and burner heat intensity. Then, the automated cooking process is initiated, prompting the system to activate the burner, and execute the specified wok motion for the predetermined duration. The user can then add the necessary food products to be automatically cooked by the system.

Although the invention has been explained in relation to its preferred embodiment, it is to be understood that many other possible modifications and variations can be made without departing from the spirit and scope of the invention.

What is claimed is:

1. A portable automated wok agitation system comprising:
a mounting plate;
a motorized arm assembly;
a motorized wrist assembly;
a controller;
a portable power source;
the motorized arm assembly comprising an arm motor, a connecting arm, a guiding rail, a sliding carriage, an arm crank, and a rocker link;
the mounting plate comprising a front edge and a rear edge;
the rocker link comprising a pivoting link end and a fixed link end;
the connecting arm comprising a proximal arm end and a distal arm end;
the arm motor comprising an arm rotor and an arm stator;
the arm stator being mounted onto the mounting plate, adjacent to the rear edge;
the pivoting link end being pivotally connected to the mounting plate, adjacent to the front edge;
the proximal arm end being torsionally connected to the arm rotor by the arm crank;
the guiding rail being positioned parallel to the connecting arm;
the guiding rail being mounted along the connecting arm;
the sliding carriage being slidably mounted along the guiding rail;
the fixed link end being connected to the sliding carriage, opposite to the connecting arm;
the motorized wrist assembly being mounted onto the connecting arm, adjacent to the distal arm end;
the arm motor being electronically connected to the controller; and
the arm motor being electrically connected to the portable power source.

2. The portable automated wok agitation system as claimed in claim 1 comprising:
the arm crank comprising a first crank end and a second crank end;
the first crank end being positioned opposite to the second crank end along the arm crank;
the first crank end of the arm crank being torsionally connected to the arm rotor; and
the second crank end of the arm crank being pivotally connected to the proximal arm end.

3. The portable automated wok agitation system as claimed in claim 2 comprising:
an angle sensor;
the angle sensor being operatively connected to the first crank end of the arm crank, wherein the angle sensor is used to track the angular movement and positioning of the arm crank being rotated by the arm motor;
the angle sensor being electronically connected to the controller; and
the angle sensor being electrically connected to the portable power source.

4. The portable automated wok agitation system as claimed in claim 1 comprising:
the motorized wrist assembly comprising a clamp mount, an adjustable jaw clamp, and a propping bracket;
the clamp mount being terminally mounted onto the distal arm end;
the propping bracket being oriented perpendicular to the connecting arm;
the propping bracket being pivotally connected to the clamp mount, offset to the distal arm end;
the adjustable jaw clamp being oriented perpendicular to the propping bracket; and
the adjustable jaw clamp being mounted onto the propping bracket, adjacent to the distal arm end.

5. The portable automated wok agitation system as claimed in claim 4 comprising:
the adjustable jaw clamp comprising a first jaw, a second jaw, and a quick-release fastener;
the first jaw and the second jaw each comprising a free jaw end and a hinged jaw end;
the free jaw end being oriented away from the connecting arm;
the hinged jaw end being oriented towards the connecting arm;
the hinged jaw end of the first jaw being hingedly connected to the hinged jaw end of the second jaw;
the first jaw being mounted onto the propping bracket; and
the second jaw being laterally connected to the first jaw by the quick-release fastener.

6. The portable automated wok agitation system as claimed in claim 4 comprising:
the motorized wrist assembly further comprising at least one servomotor, at least one servo crank, at least one wrist rod, and at least one pivoting bracket;
the at least one servomotor comprising a servo rotor and a servo stator;
the at least one wrist rod comprising a proximal rod end and a distal rod end;
the servo stator being positioned opposite to the guiding rail across the connecting arm;
the servo stator being mounted onto the connecting arm, offset to the distal arm end;
the proximal rod end being torsionally connected to the servo rotor by the servo crank;
the distal rod end being pivotally connected to the propping bracket by the at least one pivoting bracket;
the at least one servomotor being electronically connected to the controller; and
the at least one servomotor being electrically connected to the portable power source.

7. The portable automated wok agitation system as claimed in claim 6 comprising:
the at least one servo crank comprising a first crank end and a second crank end;
the first crank end being positioned opposite to the second crank end along the at least one servo crank;
the first crank end of the at least one servo crank being torsionally connected to the servo rotor; and
the second crank end of the at least one servo crank being pivotally connected to the proximal rod end.

8. The portable automated wok agitation system as claimed in claim 4 comprising:
the motorized wrist assembly further comprising a pair of stabilizing rods;
the pair of stabilizing rods being positioned opposite to each other across the propping bracket;
each of the pair of stabilizing rods being oriented away from the mounting plate;
each of the pair of stabilizing rods being oriented at an acute angle with the propping bracket; and
each of the pair of stabilizing rods being terminally connected to the propping bracket, adjacent to the adjustable jaw clamp.

9. The portable automated wok agitation system as claimed in claim 1 comprising:
a mounting clamp assembly;
the mounting clamp assembly comprising a first clamp bracket, a second clamp bracket, at least one first guide groove, at least one second guide groove, a first bracket rail, and a second bracket rail;
the first clamp bracket and the second clamp bracket each comprising a first bracket end;
the at least one first guide groove, the at least one second guide groove, the first bracket rail, and the second bracket rail each being positioned parallel to the connecting arm;
the at least one first guide groove and the at least one second guide groove being positioned opposite to each other across the motorized arm assembly;
the first bracket rail being mounted onto the mounting plate, adjacent to the at least one first guide groove;
the second bracket rail being mounted onto the mounting plate, adjacent to the at least one second guide groove;
the first clamp bracket and the second clamp bracket being positioned opposite to the motorized arm assembly across the mounting plate;
the first bracket end of the first clamp bracket being slidably mounted along the first bracket rail through the at least one first guide groove; and
the first bracket end of the second clamp bracket being slidably mounted along the second bracket rail through the at least one second guide groove.

10. The portable automated wok agitation system as claimed in claim 9 comprising:
the mounting clamp assembly further comprising a plurality of first plunger orifices, a plurality of second plunger orifices, a first locking plunger, a second locking plunger, a first plunger bracket, and a second plunger bracket;
the plurality of first plunger orifices being distributed along the first bracket rail;
each of the plurality of first plunger orifices traversing through the mounting plate and into the first bracket rail;
the plurality of second plunger orifices being distributed along the second bracket rail;
each of the plurality of second plunger orifices traversing through the mounting plate and into the second bracket rail;
the first locking plunger being mounted onto the first clamp bracket by the first plunger bracket, offset to the corresponding first bracket end;
the second locking plunger being mounted onto the second clamp bracket by the second plunger bracket, offset to the corresponding first bracket end;
the first locking plunger being engaged into a selected first plunger orifice from the plurality of first plunger orifices; and
the second locking plunger being engaged into a selected second plunger orifice from the plurality of second plunger orifices.

11. The portable automated wok agitation system as claimed in claim 9 comprising:
the mounting clamp assembly further comprising a first V-shaped arm, a second V-shaped arm, a first clamp rod, a second clamp rod, a leadscrew, and a threaded hole;
the first V-shaped arm and the second V-shaped arm each comprising a first arm end, an arm elbow, and a second arm end;
the first clamp bracket and the second clamp bracket each further comprising a second bracket end;
the first clamp bracket and the second clamp bracket each being oriented towards the rear edge;
the first V-shaped arm and the second V-shaped arm each being oriented towards the rear edge;
the first clamp rod being terminally and rotatably connected in between the second bracket end of the first clamp bracket and the second bracket end of the second clamp bracket;
the first arm end of the first V-shaped arm being hingedly connected to the first clamp bracket, adjacent to the corresponding first bracket end;
the first arm end of the second V-shaped arm being hingedly connected to the second clamp bracket, adjacent to the corresponding first bracket end;
the second clamp rod being terminally and rotatably connected in between the arm elbow of the first V-shaped arm and the arm elbow of the second V-shaped arm;
the threaded hole traversing through the first clamp rod and through the second clamp rod; and
the leadscrew being threadably engaged into the threaded hole.

12. The portable automated wok agitation system as claimed in claim 11 comprising:
the leadscrew comprising a screw handle and a threaded body;
the screw handle being positioned external to the threaded hole;
the screw handle being positioned adjacent to the rear edge; and
the threaded body being threadably engaged into the threaded hole.

13. The portable automated wok agitation system as claimed in claim 11 comprising:
the mounting clamp assembly further comprising a first contact knob and a second contact knob;
the first contact knob being pivotally connected to the second arm end of the first V-shaped arm; and
the second contact knob being pivotally connected to the second arm end of the second V-shaped arm.

14. The portable automated wok agitation system as claimed in claim 1 comprising:
a first rear leg;
a second rear leg;
the first rear leg and the second rear leg each being oriented perpendicular to the mounting plate;
the first rear leg and the second rear leg being positioned parallel and offset to each other along the rear edge; and
the first rear leg and the second rear leg being terminally mounted onto the mounting plate, opposite to the motorized arm assembly.

15. The portable automated wok agitation system as claimed in claim 1 comprising:
a first front leg;
a second front leg;
a leg crossbar;
the first front leg and the second front leg each comprising a hinged leg end;
the first front leg and the second front leg being positioned parallel and offset to each other along the front edge;
the leg crossbar being terminally connected in between the first front leg and the second front leg, offset from the hinged leg end of the first front leg and the hinged leg end of the second front leg;
the hinged leg end of the first front leg being hingedly connected to the mounting plate, opposite to the motorized wrist assembly; and
the hinged leg end of the second front leg being hingedly connected to the mounting plate, opposite to the motorized wrist assembly.

16. The portable automated wok agitation system as claimed in claim 1 comprising:
a first dropdown lock;
a second dropdown lock;
the first dropdown lock and second dropdown lock being positioned parallel and offset to each other along the front edge; and
the first dropdown lock and the second dropdown lock each being mounted onto the mounting plate, offset to the motorized wrist assembly.

17. The portable automated wok agitation system as claimed in claim 16 comprising:
the first dropdown lock and the second dropdown lock each comprising a lock base, a lock bump, a lock bar, and a cam lever;
the lock base and the lock bar being oriented perpendicular to the mounting plate;
the lock bump being laterally connected to the lock base, opposite to the motorized wrist assembly; and
the lock bar being terminally and pivotally connected to the lock base by the cam lever, adjacent to the lock bump.

18. The portable automated wok agitation system as claimed in claim 1 comprising:
a scissor lift mechanism;
the motorized arm assembly being operatively mounted onto the mounting plate by the scissor lift mechanism, wherein the scissor lift mechanism is used to adjust the vertical position of the motorized arm assembly on the mounting plate;
the scissor lift mechanism being electronically connected to the controller; and
the scissor lift mechanism being electrically connected to the portable power source.

19. The portable automated wok agitation system as claimed in claim 1 comprising:
at least one burner knob actuator;
the at least one burner knob actuator being positioned offset to the mounting plate;
the at least one burner knob actuator being electronically connected to the controller; and
the at least one burner knob actuator being electrically connected to the portable power source.

20. The portable automated wok agitation system as claimed in claim 1 comprising:
a power source housing;
the power source housing being centered on the mounting plate;
the power source housing being mounted onto the mounting plate, opposite to the motorized arm assembly; and
the portable power source being mounted within the power source housing.
